(19) United States
(12) Patent Application Publication
(10) Pub. No.: US 2018/0181720 A1
(43) Pub. Date: Jun. 28, 2018

(54) SYSTEMS AND METHODS TO ASSIGN CLINICAL GOALS, CARE PLANS AND CARE PATHWAYS

(71) Applicant: General Electric Company, Schenectady, NY (US)

(72) Inventors: Michelle Ensey, Seattle, WA (US); Simeon Schwartz, White Plains, NY (US); Art L. Forni, White Plains, NY (US); Sanjay Chopra, Seattle, WA (US); Sreeram Bonde, Dallas, TX (US); Sten Herlitz, Boston, MA (US); Kiran Gabhane, Bangalore (IN); Punith Kumar, Bangalore (IN)

(21) Appl. No.: 15/479,873

(22) Filed: Apr. 5, 2017

Related U.S. Application Data
(60) Provisional application No. 62/439,359, filed on Dec. 27, 2016.

(51) Int. Cl. G06F 19/00

(52) U.S. Cl. CPC G06F 19/345; G06F 21/6245; G06F 19/3418; G06F 19/322

(57) ABSTRACT

Certain examples provide systems and methods to assign clinical goals, care plans, and/or care pathways. An example system includes a rule engine including a particularly programmed processor to process ingested clinical data for a patient with respect to a goal, identify a rule applicable to the clinical data and goal for the patient, and apply the rule to the clinical data to generate at least one of an action or a suggestion for the patient based on applying the rule to the clinical data, the at least one of an action or a suggestion applicable to a care plan for the patient to achieve the goal. The example system also includes a rule repository storing rules and associated information for access by the rule engine.

### RELATED APPLICATIONS

This patent claims priority to U.S. Provisional Application Ser. No. 62/439,359, entitled “SYSTEMS AND METHODS TO ASSIGN CLINICAL GOALS, CARE PLANS AND CARE PATHWAYS”, filed Dec. 27, 2016, which is incorporated herein by reference in its entirety.

### BACKGROUND

The statements in this section merely provide background information related to the disclosure and may not constitute prior art.

A challenge of current Electronic Medical Record (EMR) systems is a limited ability to support the complexity of medical practice activities. Activities include management, registration, rooming, encounter, visit summary, and billing. Current EMRs are limited to the encounter activity, large on-premise solutions or bolt-ons to existing systems add value or close technology gaps. Many EMRs were built when the technology was not as robust, and data entry was more valuable than data aggregation and big data management.

Additionally, with new regulations forcing a pay for performance healthcare system, patient compliance and evidence of care becomes increasingly important. Currently, non-discreet data is entered into the patient chart as a care plan, but that data is not searchable or analyzable as non-discreet data. Providers have a limited amount of time and cognitive energy and cannot devote time to properly understand the available data.

### BRIEF SUMMARY

Certain examples provide systems and methods to assign clinical goals, care plans, and/or care pathways.

An example system includes a rule engine including a particularly programmed processor to process ingested clinical data for a patient with respect to a goal, identify a rule applicable to the clinical data and goal for the patient, and apply the rule to the clinical data to generate at least one of an action or a suggestion for the patient based on applying the rule to the clinical data, the at least one of an action or a suggestion applicable to a care plan for the patient to achieve the goal. The example system also includes a rule repository storing rules and associated information for access by the rule engine.

An example tangible computer-readable storage medium includes instructions which, when executed, particularly configure a processor to implement a system. The example system includes a rule engine to process ingested clinical data for a patient with respect to a goal, identify a rule applicable to the clinical data and goal for the patient, and apply the rule to the clinical data to generate at least one of an action or a suggestion for the patient based on applying the rule to the clinical data, the at least one of an action or a suggestion applicable to a care plan for the patient to achieve the goal. The example system also includes a rule repository storing rules and associated information for access by the rule engine.

An example computer-implemented method includes: processing, using a processor, ingested clinical data for a patient with respect to a goal; identifying, using the processor, a rule applicable to the clinical data and goal for the patient; an applying, using the processor, the rule to the clinical data to generate at least one of an action or a suggestion for the patient based on applying the rule to the clinical data, the at least one of an action or a suggestion applicable to a care plan for the patient to achieve the goal.

Example computer-readable media, systems, and/or other apparatus can be used to implement methods disclosed herein.

### BRIEF DESCRIPTION OF THE DRAWINGS

The features and technical aspects of the system and method disclosed herein will become apparent in the following Detailed Description set forth below when taken in conjunction with the drawings in which like reference numerals indicate identical or functionally similar elements.

FIG. 1 shows a block diagram of an example healthcare-focused information system.

FIG. 2 shows a block diagram of an example healthcare information infrastructure including one or more systems.

FIG. 3 shows an example industrial internet configuration including a plurality of health-focused systems.

FIG. 4 illustrates an example clinical decision support system including an electronic medical record system and a rules engine.

FIG. 5 illustrates an example system in which the electronic medical record works with a cloud database and a batch rule engine.

FIG. 6 illustrates an example rules engine application container.

FIG. 7 illustrates an example implementation of the rules engine of FIG. 6.

FIG. 8 illustrates a flow diagram of an example rules engine execution flow among rules engine components to build and execute a rule for a given input.

FIG. 9 illustrates a flow diagram of an example method for a batch process flow to provide recommendation and/or other data to a clinician based on patient history and facts.

FIG. 10 shows an example rules engine implemented in a cloud and interacting with a local, on-premise information system.

FIG. 11 illustrates an example testing and production environment for rules drafting, testing, and production.

FIG. 12 illustrates an example clinical decision support system including a data and rules repository.

FIG. 13 illustrates an example implementation of a rules engine and associated repository embedded in one or more other clinical applications.

FIG. 14 provides a data flow for clinical quality reporting using the rules engine.

FIG. 15 illustrates an architectural block diagram of an example clinical decision support system including the rules engine.

FIG. 16 illustrates another example block diagram of a system integrating a partner system with a clinical decision support system and a clinical practice solutions and/or electronic medical records system.

FIG. 17 illustrates an example clinical decision support system leveraging the rules engine as part of the clinical decision support to generate an improved patient outcome.

FIG. 18 illustrates a flow diagram of an example method of patient care plan and rule composition, monitoring, and adjustment using the example rules engine and associated clinical decision support.

FIG. 19 is a block diagram of an example processor platform capable of executing instructions to implement the example systems and methods of FIGS. 1-18.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

### I. Overview

Care plans are discreet and/or non-discreet data entered into the electronic medical record organized by each care event. A care plan is organized by problem or condition and represents standard(s) and protocol(s) for patient care based on payer and clinical guideline(s). By organizing and correlating discrete and non-discrete care pathway data in a medical record to clinical problem(s), condition(s) and/or comorbidities, care plans become repeatable and measurable standards of care. Care plans can be based on a specific payer, clinical standards of practice, and/or clinician specific guidelines, for example. Furthermore, problem oriented organization of data relevant to the problem and/or condition becomes automatable and actionable at the point of care when relevant.

A care pathway uses electronic medical record (EMR) and payer data to recommend intervention(s), activities and/or tasks appropriate for a patient's problem or set of problems. Productivity can be further improved by using a rules engine in conjunction with data input automating workflow, activities and/or tasks, when possible, based on clinical decision support intervention and/or other types of rules. The rules drive automation for an EMR system using tasking, alerts, and/or recommendations, for example. Thus, various portions of medical practice activities (e.g., management, registration, rooming, encounter, visit summary, billing) can be completed by facilitating the workflow to eliminate manual processes. Care pathway recommendations and/or workflow elements that cannot be automated are served up in the system workflow for manual intervention in orchestration with the automated recommendations, workflow, activities and/or tasks, for example.

Certain examples use a role-based rules system to determine access, workflows, activities, tasks, alerts and suggestions to be presented to complete activities. The system also allows for both role-based rules and individual custom rules to be created. Certain examples provide an ability to drive page content navigation to complete tasks.

An example of care plans with care pathways organized by problem and/or condition is as follows. Suppose a patient is over the age of 13 and is consulting medical professional for problem and/or condition of routine medical care. Routine correlated rules advise a practitioner to inquire if the patient smokes. An inquiry response can be extrapolated into preventative actions and/or more complex problems and/or conditions related to smoking that should be considered in the care pathway for the patient. Furthermore, if the patient has family or other relevant histories documented, rules can advise interventions such as a mammogram for breast cancer screening.

Clinical goals allow for a provider to compare patient data to a reference data point as well as set a smaller achievable goal. For example, regardless of whether a patient value is out of a reference range, a patient may have a more achievable goal. A clinical goal allows a provider to provide evidence-based care and tracking of patient compliance. Certain examples provide system and methods to relate reference values to a patient result and allow for a provider to set other patient-specific goals.

Certain examples provide systems and methods to facilitate clinical problem and guideline-based clinical care through problem-oriented organization of clinical information, care plans, pathways, and goals. An example workflow introduces clinical information organized and correlated by medical decision (problem) in conjunction with guidelines and decision support at the point of care and assists users (e.g., EMR users, clinical practice management/clinical practice solution system (CPS) users, etc.) to identify gaps in patient care and improve care quality through structured care plans inside the workflow. In certain examples, productivity can be further improved by automating workflow based on clinical decision support and business process rules.

With new regulations forcing a pay-for-performance healthcare system, patient compliance and evidence of care becomes increasingly important. Providers have a limited amount of time and cognitive energy to apply to patient care. By providing a solution that decreases the amount of cognitive load and time required for initial and mundane diagnostics, providers can instead exert their cognitive energy on more complex conditions.

Organizing structured care plans, pathway, and goals around problems and/or conditions can help EMR users decrease cognitive load while inside their workflow to identify gaps in patient care and opportunities to improve care quality. Benchmark goals can help to prevent and improve overall health. By intervening earlier patient outcomes are also improved, medical cost of a life time decreases. Medical evidence is also validated or improved upon.

In prior systems, non-discrete data is entered into a patient chart as one or more care plans. In certain examples, by correlating the non-discrete information to a clinical condition and comorbidities, problem-oriented views of clinical data can be generated that are actionable at a point of care. Furthermore, parsing out clinical goals transforms the non-discrete data into discrete data that is searchable. Certain examples allow additional rules to be run and become part of decision making at a point of care to enable clinicians to act on the data.

Certain examples organize structured care plans, pathways and goals around problems and/or conditions to assist EMR and/or CPS users to identify gaps in patient care and improve care quality while inside their workflow. User productivity can be further improved by automating workflow based on clinical decision support and business process rules that provide standardization and reduce laborious and costly manual processes.

Organizations can create their own standards of care and/or protocols to be used as guidelines, processes and/or policies for the organizations. In certain examples, a plug-in product that authors guideline content that can be referenced outside of a patient visit workflow. By organizing by problems and conditions and tying them to rules and a rules engine, certain examples facilitate a workflow not achieved by prior EMR or CPS systems.

Alternatively, a plug-in product can be provided to author guideline content that can be referenced outside of a patient visit workflow, for example. Using machine learning technologies, unlabeled data can be provided around a subject area, such as smoking, and allow the system to determine points of intervention.

Prior EMRs are very transactional and involve much user data entry. Certain examples move the data entry burden and introduce some machine intelligence. Certain examples use system intelligence and power of data to improve user and patient workflow and patient treatment. For example, a patient is treated by listening, coming to a decision, and setting goals to evaluate how the patient is doing with the treatment. For example, if a user prescribes immoxicilin for 14 days, certain examples provide a listener device in the system to process the order amount and time. The listener identifies when the patient has picked up the prescription from a pharmacy, and, if the listener does not detect a transaction to indicate that the patient has picked up his or her prescription, then the listener device triggers a task/activity to contact patient and inquire regarding the prescription, contact the pharmacy, etc., to help ensure there is no barrier to patient pick up of the prescription (e.g., patient cannot afford a co-pay, patient has no transport to get to pharmacy, etc.). Thus, listeners can be wrapped around transactions and/or other background tasks in a patient care plan/workflow.

In certain examples, care plan goals can be associated with listener devices to monitor progress toward and/or achievement of those goals. For example, if a patient has problems related to low-density lipoprotein (LDL), a doctor can prescribe medication as well as recommend a modification to diet and exercise with a goal to reduce weight by three pounds in four weeks. A listener can be associated with the care plan and goal. If the listener follows and evaluates program and determines whether or not the goal has not been met in four weeks. Based on the outcome, recommendations can be generated (e.g., more intrusive interventions (e.g., weight loss counseling, hypnotherapist, medication, etc.) or less intrusive inventions, etc., based on positive or negative outcome).

Certain examples also automate patient care workflows. For example, if a physician places an order or refers a patient for an x-ray imaging, heart monitoring, etc., and the patient does not comply (e.g., because the patient does not have enough time, the patient does not have enough money, the patient is not interested, etc.), the physician is penalized for lack of care. A notification or alert regarding the penalty can be surfaced in the workflow such that the system identifies the order or referral as well as the lack of completion or follow-through and triggers a notification (e.g., a note to a care manager to follow up with the patient, etc.).

Certain examples also provide business process rules to indicate and/or document aspects of patient care to help ensure providers are paid correctly for work being done. A rule defines a timing and/or other condition for a corresponding behavior and can also include other behavior(s) to be executed in order to be paid by an insurer. In certain examples, the system parses and understands care protocol and payment guidelines and guides and guides a user through the guidelines to help ensure proper care and payment.

In certain examples, ambulatory data (e.g., some discrete data and some non-discrete data, etc.) is stored in a data repository, such as an EMR, and an authoring tool is provided to author medical guidelines in real time and/or substantially real time (e.g., given data transmission, processing, storage, and/or retrieval delay) with clinical decision support. For example, a user can author rules that indicate if certain conditions are met, then corresponding activities are executed. For example, if a diabetes code is identified and the patient is over age 45, then the patient is recommended for a foot examination every year. Rules can be written to leverage the environment and terminology.

For example, suppose a patient is a diabetic and should get an A1C every year. A terminology service looks for a Logical Observation Identifiers Names and Codes (LOINC) code of A1C, which triggers a rule to search for an A1C appointment on the patient's chart. If such an appointment is not found, the rule suggests and/or makes an A1C appointment for the patient to evaluate that patient's glycated hemoglobin A1C level of average (e.g., 3 month) plasma glucose concentration.

In another example, the system can evaluate EMR ambulatory data and use a rules engine to apply rules and produce a recommendation. The recommendation can be displayed via a graphical user interface (GUI), and a user can then order a hemoglobin A1C for the patient. Once the A1C result comes back and does not satisfy a parameter within a normal range, an additional recommendation can indicate more frequent A1C reviews, increase medication, etc. In certain examples, a payer can have a similar rule to the provider A1C rule recommending an A1C review every three months. The payer rule can come into the repository and trump the provider rule of once a year to set the schedule more frequently and bridge the information loop, for example.

In certain examples, data, rules, and/or processing, etc., can be located on-premises at a healthcare facility. In certain examples, data, rules, and/or processing, etc., can be provided in a cloud-based implementation (e.g., run through a cloud storage factory with recommendations manifesting in cloud orders, etc.). In a cloud-based implementation, an on-premise database is located in a cloud, so customers do not have to migrate data to a different database. Instead, users have a common data factory to leverage that data for batch rules, clinical decision support, etc.

Thus, certain examples facilitate improved care quality through application of rules, monitoring, and improved patient outcomes (e.g., patients are cheaper to care for, less likely to have certain events, etc.). Certain examples provide actionable insights at a right time and place. Information is provided inside a workflow at a point at which the information is relevant to the workflow. A rule runs and a result appears inside an order screen where a user is placing the order, for example. A recommendation modifies a user's screen in real time to impact his or her workflow in the moment when/where the user is making decisions related to the recommendation.

As will be described further below, certain examples can integrate with and operate in a variety of healthcare environments and impact a variety of healthcare scenarios and data through sensing, decision support, workflow management, and control. The following section provides some context and example environment for the presently disclosed technology described further in the subsequent section below.

### II. Example Operating Environments

Health information, also referred to as healthcare information and/or healthcare data, relates to information generated and/or used by a healthcare entity. Health information can be information associated with health of one or more patients, for example. Health information may include protected health information (PHI), as outlined in the Health Insurance Portability and Accountability Act (HIPAA), which is identifiable as associated with a particular patient and is protected from unauthorized disclosure. Health information can be organized as internal information and external information. Internal information includes patient encounter information (e.g., patient-specific data, aggregate data, comparative data, etc.) and general healthcare operations information, etc. External information includes comparative data, expert and/or knowledge-based data, etc. Information can have both a clinical (e.g., diagnosis, treatment, prevention, etc.) and administrative (e.g., scheduling, billing, management, etc.) purpose.

Institutions, such as healthcare institutions, having complex network support environments and sometimes chaotically driven process flows utilize secure handling and safeguarding of the flow of sensitive information (e.g., personal privacy). A need for secure handling and safeguarding of information increases as a demand for flexibility, volume, and speed of exchange of such information grows. For example, healthcare institutions provide enhanced control and safeguarding of the exchange and storage of sensitive patient PHI and employee information between diverse locations to improve hospital operational efficiency in an operational environment typically having a chaotic-driven demand by patients for hospital services. In certain examples, patient identifying information can be masked or even stripped from certain data depending upon where the data is stored and who has access to that data. In some examples, PHI that has been “de-identified” can be re-identified based on a key and/or other encoder/decoder.

A healthcare information technology infrastructure can be adapted to service multiple business interests while providing clinical information and services. Such an infrastructure may include a centralized capability including, for example, a data repository, reporting, discrete data exchange/connectivity, “smart” algorithms, personalization/consumer decision support, etc. This centralized capability provides information and functionality to a plurality of users including medical devices, electronic records, access portals, pay for performance (P4P), chronic disease models, and clinical health information exchange/regional health information organization (HIE/RHIO), and/or enterprise pharmaceutical studies, home health, for example.

Interconnection of multiple data sources helps enable an engagement of all relevant members of a patient's care team and helps improve an administrative and management burden on the patient for managing his or her care. Particularly, interconnecting the patient's electronic medical record and/or other medical data can help improve patient care and management of patient information. Furthermore, patient care compliance is facilitated by providing tools that automatically adapt to the specific and changing health conditions of the patient and provide comprehensive education and compliance tools to drive positive health outcomes.

In certain examples, healthcare information can be distributed among multiple applications using a variety of database and storage technologies and data formats. To provide a common interface and access to data residing across these applications, a connectivity framework (CF) can be provided which leverages common data and service models (CDM and CSM) and service oriented technologies, such as an enterprise service bus (ESB) to provide access to the data.

In certain examples, a variety of user interface frameworks and technologies can be used to build applications for health information systems including, but not limited to, MICROSOFT® ASP.NET, AJAX®, MICROSOFT® Windows Presentation Foundation, GOOGLE® Web Toolkit, MICROSOFT® Silverlight, ADOBE®, and others. Applications can be composed from libraries of information widgets to display multi-content and multi-media information, for example. In addition, the framework enables users to tailor layout of applications and interact with underlying data.

In certain examples, an advanced Service-Oriented Architecture (SOA) with a modern technology stack helps provide robust interoperability, reliability, and performance. Example SOA includes a three-fold interoperability strategy including a central repository (e.g., a central repository built from Health Level Seven (HL7) transactions), services for working in federated environments, and visual integration with third-party applications. Certain examples provide portable content enabling plug 'n play content exchange among healthcare organizations. A standardized vocabulary using common standards (e.g., LOINC, SNOMED CT, RxNorm, FDB, ICD-9, ICD-10, etc.) is used for interoperability, for example. Certain examples provide an intuitive user interface to help minimize end-user training. Certain examples facilitate user-initiated launching of third-party applications directly from a desktop interface to help provide a seamless workflow by sharing user, patient, and/or other contexts. Certain examples provide real-time (or at least substantially real time assuming some system delay) patient data from one or more information technology (IT) systems and facilitate comparison(s) against evidence-based best practices. Certain examples provide one or more dashboards for specific sets of patients. Dashboard(s) can be based on condition, role, and/or other criteria to indicate variation(s) from a desired practice, for example.

A. Example Healthcare Information System

An information system can be defined as an arrangement of information/data, processes, and information technology that interact to collect, process, store, and provide informational output to support delivery of healthcare to one or more patients. Information technology includes computer technology (e.g., hardware and software) along with data and telecommunications technology (e.g., data, image, and/or voice network, etc.).

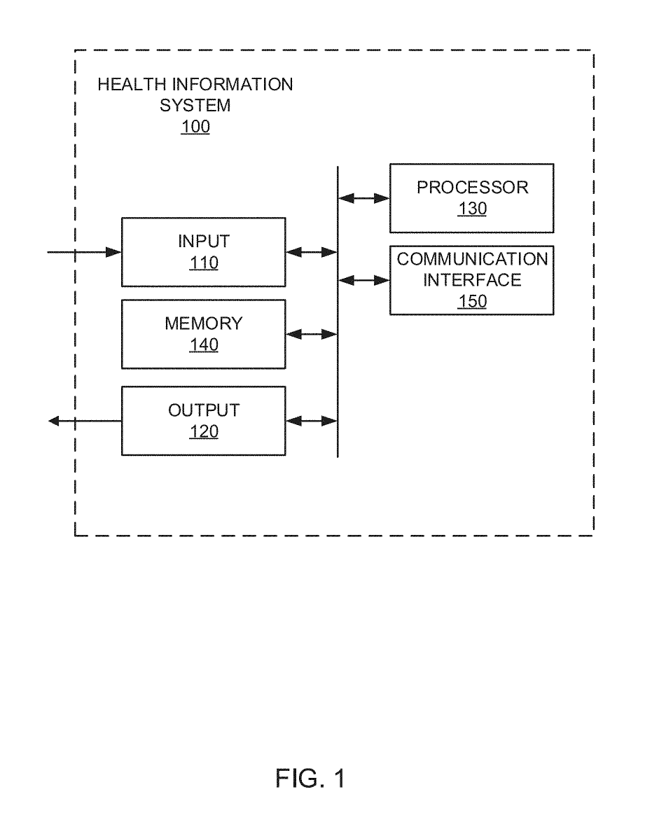

Turning now to the figures, FIG. 1 shows a block diagram of an example healthcare-focused information system 100. Example system 100 can be configured to implement a variety of systems and processes including image storage (e.g., picture archiving and communication system (PACS), etc.), image processing and/or analysis, radiology reporting and/or review (e.g., radiology information system (RIS), etc.), computerized provider order entry (CPOE) system, clinical decision support, patient monitoring, population health management (e.g., population health management system (PHMS), health information exchange (HIE), etc.), healthcare data analytics, cloud-based image sharing, electronic medical record (e.g., electronic medical record system (EMR), electronic health record system (EHR), electronic patient record (EPR), personal health record system (PHR), etc.), and/or other health information system (e.g., clinical information system (CIS), hospital information system (HIS), patient data management system (PDMS), laboratory information system (LIS), cardiovascular information system (CVIS), etc.

As illustrated in FIG. 1, the example information system 100 includes an input 110, an output 120, a processor 130, a memory 140, and a communication interface 150. The components of example system 100 can be integrated in one device or distributed over two or more devices.

Example input 110 may include a keyboard, a touch-screen, a mouse, a trackball, a track pad, optical barcode recognition, voice command, etc. or combination thereof used to communicate an instruction or data to system 100. Example input 110 may include an interface between systems, between user(s) and system 100, etc.

Example output 120 can provide a display generated by processor 130 for visual illustration on a monitor or the like. The display can be in the form of a network interface or graphic user interface (GUI) to exchange data, instructions, or illustrations on a computing device via communication interface 150, for example. Example output 120 may include a monitor (e.g., liquid crystal display (LCD), plasma display, cathode ray tube (CRT), etc.), light emitting diodes (LEDs), a touch-screen, a printer, a speaker, or other conventional display device or combination thereof.

Example processor 130 includes hardware and/or software configuring the hardware to execute one or more tasks and/or implement a particular system configuration. Example processor 130 processes data received at input 110 and generates a result that can be provided to one or more of output 120, memory 140, and communication interface 150. For example, example processor 130 can take user annotation provided via input 110 with respect to an image displayed via output 120 and can generate a report associated with the image based on the annotation. As another example, processor 130 can process updated patient information obtained via input 110 to provide an updated patient record to an EMR via communication interface 150.

Example memory 140 may include a relational database, an object-oriented database, a data dictionary, a clinical data repository, a data warehouse, a data mart, a vendor neutral archive, an enterprise archive, etc. Example memory 140 stores images, patient data, best practices, clinical knowledge, analytics, reports, etc. Example memory 140 can store data and/or instructions for access by the processor 130. In certain examples, memory 140 can be accessible by an external system via the communication interface 150.

In certain examples, memory 140 stores and controls access to encrypted information, such as patient records, encrypted update-transactions for patient medical records, including usage history, etc. In an example, medical records can be stored without using logic structures specific to medical records. In such a manner, memory 140 is not searchable. For example, a patient's data can be encrypted with a unique patient-owned key at the source of the data. The data is then uploaded to memory 140. Memory 140 does not process or store unencrypted data thus minimizing privacy concerns. The patient's data can be downloaded and decrypted locally with the encryption key.

For example, memory 140 can be structured according to provider, patient, patient/provider association, and document. Provider information may include, for example, an identifier, a name, and address, a public key, and one or more security categories. Patient information may include, for example, an identifier, a password hash, and an encrypted email address. Patient/provider association information may include a provider identifier, a patient identifier, an encrypted key, and one or more override security categories. Document information may include an identifier, a patient identifier, a clinic identifier, a security category, and encrypted data, for example.

Example communication interface 150 facilitates transmission of electronic data within and/or among one or more systems. Communication via communication interface 150 can be implemented using one or more protocols. In some examples, communication via communication interface 150 occurs according to one or more standards (e.g., Digital Imaging and Communications in Medicine (DICOM), Health Level Seven (HL7), ANSI X12N, etc.). Example communication interface 150 can be a wired interface (e.g., a data bus, a Universal Serial Bus (USB) connection, etc.) and/or a wireless interface (e.g., radio frequency, infrared (IR), near field communication (NFC), etc.). For example, communication interface 150 may communicate via wired local area network (LAN), wireless LAN, wide area network (WAN), etc. using any past, present, or future communication protocol (e.g., BLUETOOTH™, USB 2.0, USB 3.0, etc.).

In certain examples, a Web-based portal may be used to facilitate access to information, patient care and/or practice management, etc. Information and/or functionality available via the Web-based portal may include one or more of order entry, laboratory test results review system, patient information, clinical decision support, medication management, scheduling, electronic mail and/or messaging, medical resources, etc. In certain examples, a browser-based interface can serve as a zero footprint, zero download, and/or other universal viewer for a client device.

In certain examples, the Web-based portal serves as a central interface to access information and applications, for example. Data may be viewed through the Web-based portal or viewer, for example. Additionally, data may be manipulated and propagated using the Web-based portal, for example. Data may be generated, modified, stored and/or used and then communicated to another application or system to be modified, stored and/or used, for example, via the Web-based portal, for example.

The Web-based portal may be accessible locally (e.g., in an office) and/or remotely (e.g., via the Internet and/or other private network or connection), for example. The Web-based portal may be configured to help or guide a user in accessing data and/or functions to facilitate patient care and practice management, for example. In certain examples, the Web-based portal may be configured according to certain rules, preferences and/or functions, for example. For example, a user may customize the Web portal according to particular desires, preferences and/or requirements.

B. Example Healthcare Infrastructure

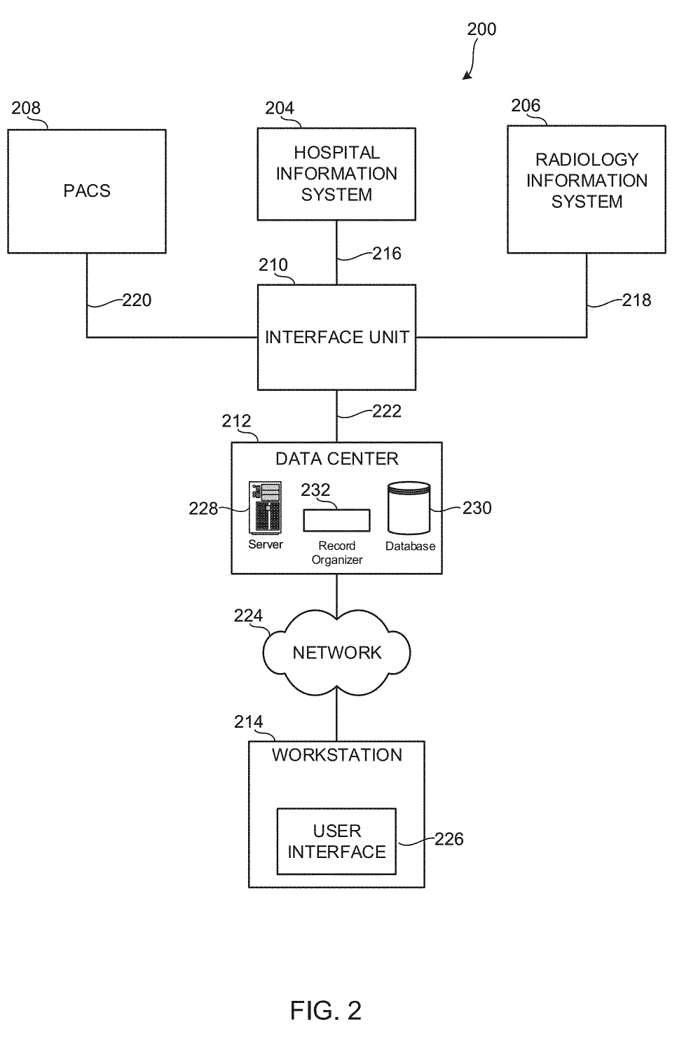

FIG. 2 shows a block diagram of an example healthcare information infrastructure 200 including one or more subsystems such as the example healthcare-related information system 100 illustrated in FIG. 1. Example healthcare system 200 includes a HIS 204, a RIS 206, a PACS 208, an interface unit 210, a data center 212, and a workstation 214. In the illustrated example, HIS 204, RIS 206, and PACS 208 are housed in a healthcare facility and locally archived. However, in other implementations, HIS 204, RIS 206, and/or PACS 208 may be housed within one or more other suitable locations. In certain implementations, one or more of PACS 208, RIS 206, HIS 204, etc., may be implemented remotely via a thin client and/or downloadable software solution. Furthermore, one or more components of the healthcare system 200 can be combined and/or implemented together. For example, RIS 206 and/or PACS 208 can be integrated with HIS 204; PACS 208 can be integrated with RIS 206; and/or the three example information systems 204, 206, and/or 208 can be integrated together. In other example implementations, healthcare system 200 includes a subset of the illustrated information systems 204, 206, and/or 208. For example, healthcare system 200 may include only one or two of HIS 204, RIS 206, and/or PACS 208. Information (e.g., scheduling, test results, exam image data, observations, diagnosis, etc.) can be entered into HIS 204, RIS 206, and/or PACS 208 by healthcare practitioners (e.g., radiologists, physicians, and/or technicians) and/or administrators before and/or after patient examination. One or more of the HIS 204, RIS 206, and/or PACS 208 can communicate with equipment and system(s) in an operating room, patient room, etc., to track activity, correlate information, generate reports and/or next actions, and the like.

The HIS 204 stores medical information such as clinical reports, patient information, and/or administrative information received from, for example, personnel at a hospital, clinic, and/or a physician's office (e.g., an EMR, EHR, PHR, etc.). RIS 206 stores information such as, for example, radiology reports, radiology exam image data, messages, warnings, alerts, patient scheduling information, patient demographic data, patient tracking information, and/or physician and patient status monitors. Additionally, RIS 206 enables exam order entry (e.g., ordering an x-ray of a patient) and image and film tracking (e.g., tracking identities of one or more people that have checked out a film). In some examples, information in RIS 206 is formatted according to the HL-7 (Health Level Seven) clinical communication protocol. In certain examples, a medical exam distributor is located in RIS 206 to facilitate distribution of radiology exams to a radiologist workload for review and management of the exam distribution by, for example, an administrator.

PACS 208 stores medical images (e.g., x-rays, scans, three-dimensional renderings, etc.) as, for example, digital images in a database or registry. In some examples, the medical images are stored in PACS 208 using the Digital Imaging and Communications in Medicine (DICOM) format. Images are stored in PACS 208 by healthcare practitioners (e.g., imaging technicians, physicians, radiologists) after a medical imaging of a patient and/or are automatically transmitted from medical imaging devices to PACS 208 for storage. In some examples, PACS 208 can also include a display device and/or viewing workstation to enable a healthcare practitioner or provider to communicate with PACS 208.

The interface unit 210 includes a hospital information system interface connection 216, a radiology information system interface connection 218, a PACS interface connection 220, and a data center interface connection 222. Interface unit 210 facilities communication among HIS 204, RIS 206, PACS 208, and/or data center 212. Interface connections 216, 218, 220, and 222 can be implemented by, for example, a Wide Area Network (WAN) such as a private network or the Internet. Accordingly, interface unit 210 includes one or more communication components such as, for example, an Ethernet device, an asynchronous transfer mode (ATM) device, an 802.11 device, a DSL modem, a cable modem, a cellular modem, etc. In turn, the data center 212 communicates with workstation 214, via a network 224, implemented at a plurality of locations (e.g., a hospital, clinic, doctor's office, other medical office, or terminal, etc.). Network 224 is implemented by, for example, the Internet, an intranet, a private network, a wired or wireless Local Area Network, and/or a wired or wireless Wide Area Network. In some examples, interface unit 210 also includes a broker (e.g., a Mitra Imaging's PACS Broker) to allow medical information and medical images to be transmitted together and stored together.

Interface unit 210 receives images, medical reports, administrative information, exam workload distribution information, and/or other clinical information from the information systems 204, 206, 208 via the interface connections 216, 218, 220. If necessary (e.g., when different formats of the received information are incompatible), interface unit 210 translates or reformats (e.g., into Structured Query Language (“SQL”) or standard text) the medical information, such as medical reports, to be properly stored at data center 212. The reformatted medical information can be transmitted using a transmission protocol to enable different medical information to share common identification elements, such as a patient name or social security number. Next, interface unit 210 transmits the medical information to data center 212 via data center interface connection 222. Finally, medical information is stored in data center 212 in, for example, the DICOM format, which enables medical images and corresponding medical information to be transmitted and stored together.

The medical information is later viewable and easily retrievable at workstation 214 (e.g., by their common identification element, such as a patient name or record number). Workstation 214 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. Workstation 214 receives commands and/or other input from a user via, for example, a keyboard, mouse, track ball, microphone, etc. Workstation 214 is capable of implementing a user interface 226 to enable a healthcare practitioner and/or administrator to interact with healthcare system 200. For example, in response to a request from a physician, user interface 226 presents a patient medical history. In other examples, a radiologist is able to retrieve and manage a workload of exams distributed for review to the radiologist via user interface 226. In further examples, an administrator reviews radiologist workloads, exam allocation, and/or operational statistics associated with the distribution of exams via user interface 226. In some examples, the administrator adjusts one or more settings or outcomes via user interface 226.

Example data center 212 of FIG. 2 is an archive to store information such as images, data, medical reports, and/or, more generally, patient medical records. In addition, data center 212 can also serve as a central conduit to information located at other sources such as, for example, local archives, hospital information systems/radiology information systems (e.g., HIS 204 and/or RIS 206), or medical imaging/storage systems (e.g., PACS 208 and/or connected imaging modalities). That is, the data center 212 can store links or indicators (e.g., identification numbers, patient names, or record numbers) to information. In the illustrated example, data center 212 is managed by an application server provider (ASP) and is located in a centralized location that can be accessed by a plurality of systems and facilities (e.g., hospitals, clinics, doctor's offices, other medical offices, and/or terminals). In some examples, data center 212 can be spatially distant from HIS 204, RIS 206, and/or PACS 208.

Example data center 212 of FIG. 2 includes a server 228, a database 230, and a record organizer 232. Server 228 receives, processes, and conveys information to and from the components of healthcare system 200. Database 230 stores the medical information described herein and provides access thereto. Example record organizer 232 of FIG. 2 manages patient medical histories, for example. Record organizer 232 can also assist in procedure scheduling, for example.

Certain examples can be implemented as cloud-based clinical information systems and associated methods of use. An example cloud-based clinical information system enables healthcare entities (e.g., patients, clinicians, sites, groups, communities, and/or other entities) to share information via web-based applications, cloud storage and cloud services. For example, the cloud-based clinical information system may enable a first clinician to securely upload information into the cloud-based clinical information system to allow a second clinician to view and/or download the information via a web application. Thus, for example, the first clinician may upload an x-ray image into the cloud-based clinical information system, and the second clinician may view the x-ray image via a web browser and/or download the x-ray image onto a local information system employed by the second clinician.

In certain examples, users (e.g., a patient and/or care provider) can access functionality provided by system 200 via a software-as-a-service (SaaS) implementation over a cloud or other computer network, for example. In certain examples, all or part of system 200 can also be provided via platform as a service (PaaS), infrastructure as a service (IaaS), etc. For example, system 200 can be implemented as a cloud-delivered Mobile Computing Integration Platform as a Service. A set of consumer-facing Web-based, mobile, and/or other applications enable users to interact with the PaaS, for example.

C. Industrial Internet Examples

The Internet of things (also referred to as the “Industrial Internet”) relates to an interconnection between a device that can use an Internet connection to talk with other devices on the network. Using the connection, devices can communicate to trigger events/actions (e.g., changing temperature, turning on/off, providing a status, etc.). In certain examples, machines can be merged with “big data” to improve efficiency and operations, provide improved data mining, facilitate better operation, etc.

Big data can refer to a collection of data so large and complex that it becomes difficult to process using traditional data processing tools/methods. Challenges associated with a large data set include data capture, sorting, storage, search, transfer, analysis, and visualization. A trend toward larger data sets is due at least in part to additional information derivable from analysis of a single large set of data, rather than analysis of a plurality of separate, smaller data sets. By analyzing a single large data set, correlations can be found in the data, and data quality can be evaluated.

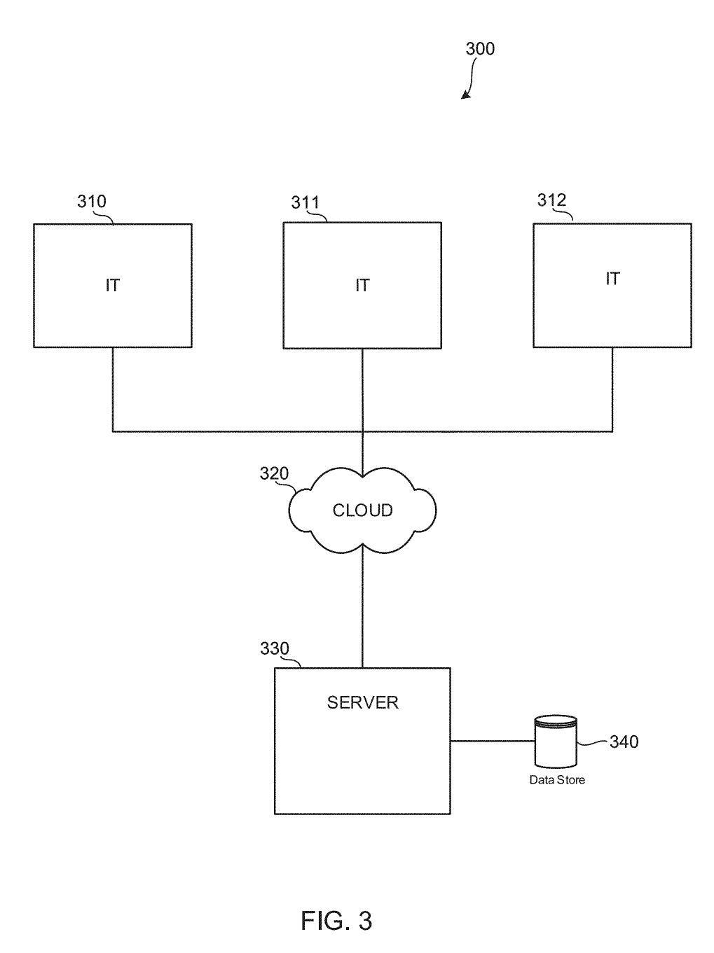

FIG. 3 illustrates an example industrial internet configuration 300. Example configuration 300 includes a plurality of health-focused systems 310-312, such as a plurality of health information systems 100 (e.g., PACS, RIS, EMR, etc.) communicating via industrial internet infrastructure 300. Example industrial internet 300 includes a plurality of health-related information systems 310-312 communicating via a cloud 320 with a server 330 and associated data store 340.

As shown in the example of FIG. 3, a plurality of devices (e.g., information systems, imaging modalities, etc.) 310-312 can access a cloud 320, which connects the devices 310-312 with a server 330 and associated data store 340. Information systems, for example, include communication interfaces to exchange information with server 330 and data store 340 via the cloud 320. Other devices, such as medical imaging scanners, patient monitors, etc., can be outfitted with sensors and communication interfaces to enable them to communicate with each other and with the server 330 via the cloud 320.

Thus, machines 310-312 within system 300 become “intelligent” as a network with advanced sensors, controls, analytical based decision support and hosting software applications. Using such an infrastructure, advanced analytics can be provided to associated data. The analytics combines physics-based analytics, predictive algorithms, automation, and deep domain expertise. Via cloud 320, devices 310-312 and associated people can be connected to support more intelligent design, operations, maintenance, and higher server quality and safety, for example.

Using the industrial internet infrastructure, for example, a proprietary machine data stream can be extracted from a device 310. Machine-based algorithms and data analysis are applied to the extracted data. Data visualization can be remote, centralized, etc. Data is then shared with authorized users, and any gathered and/or gleaned intelligence is fed back into the machines 310-312.

D. Data Mining Examples

Imaging informatics includes determining how to tag and index a large amount of data acquired in diagnostic imaging in a logical, structured, and machine-readable format. By structuring data logically, information can be discovered and utilized by algorithms that represent clinical pathways and decision support systems. Data mining can be used to help ensure patient safety, reduce disparity in treatment, provide clinical decision support, etc. Mining both structured and unstructured data from radiology reports, as well as actual image pixel data, can be used to tag and index both imaging reports and the associated images themselves.

E. Example Methods of Use

Clinical workflows are typically defined to include one or more steps or actions to be taken in response to one or more events and/or according to a schedule. Events may include receiving a healthcare message associated with one or more aspects of a clinical record, opening a record(s) for new patient(s), receiving a transferred patient, reviewing and reporting on an image, executing orders for specific care, signing off on orders for a discharge, and/or any other instance and/or situation that requires or dictates responsive action or processing. The actions or steps of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, radiology image reading, dispatching room cleaning and/or patient transport, and/or any other action useful in processing healthcare information or causing critical path care activities to progress. The defined clinical workflows may include manual actions or steps to be taken by, for example, an administrator or practitioner, electronic actions or steps to be taken by a system or device, and/or a combination of manual and electronic action(s) or step(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

In certain examples, a medical exam conducted on a patient can involve review by a healthcare practitioner, such as a radiologist, to obtain, for example, diagnostic information from the exam. In a hospital setting, medical exams can be ordered for a plurality of patients, all of which require review by an examining practitioner. Each exam has associated attributes, such as a modality, a part of the human body under exam, and/or an exam priority level related to a patient criticality level. Hospital administrators, in managing distribution of exams for review by practitioners, can consider the exam attributes as well as staff availability, staff credentials, and/or institutional factors such as service level agreements and/or overhead costs.

Additional workflows can be facilitated such as bill processing, revenue cycle mgmt., population health management, patient identity, consent management, etc.

### III. Example Clinical Care Engine Systems and Methods

Certain examples provide a clinical decision support system 400 including an EMR 410 and a rules engine 420. The example EMR 410 can be operated in a real time and/or batch mode. In a real-time mode, the rule engine 420 is triggered at a plurality of preconfigured trigger points in the EMR application 410. The EMR 410 pulls clinical patient data (e.g., facts) from an EMR database and sends the patient data to the rule engine 420 to generate a recommendation. The rule engine 420 loads one or more rules and applies the one or more rules to the clinical facts to generate a recommendation. The EMR 410 stores the recommendation (e.g., in a database on the cloud, etc.) and outputs (e.g., displays, etc.) the recommendation to a clinician.

In certain examples, a batch mode is triggered when data is made available on the cloud. The batch process pulls clinical facts from the data on the cloud and applies clinical batch rules to generate a recommendation. The recommendation persists on the cloud at the end of the batch process. During a patient encounter, for example, when a clinician logs into the EMR 410, the recommendation is pulled and displayed to the user.

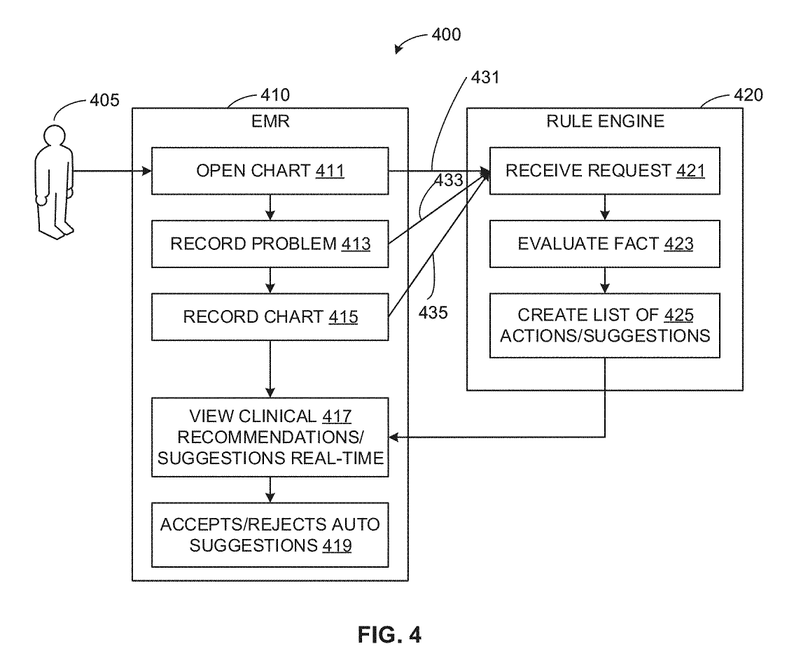

Turning to the example of FIG. 4, the physician 405 opens a patient chart 411 via the EMR 410. Opening the patient chart 411 triggers 431 the rule engine 420 to receive a request 421 for a recommendation. At the EMR 410, a patient problem is recorded 413, which also triggers 433 a request 421 at the rule engine 420. The patient chart is recorded 415 at the EMR 410, which triggers 435 another request 421 at the rule engine 420. The rule engine 420 evaluates facts 423 and creates a list of actions and/or suggestions 425 based on rules applied to the data. The rule engine 420 generates a response 437 based on the actions and/or suggestions. The EMR 410 receives the response 437 and, based on the response 437, generates clinical recommendations and/or suggestions 417 in real time and/or substantially real time given data retrieval, processing, and/or transmission delay. The EMR 410 accepts and/or rejects 419 the automatically generated recommendations and/or suggestions (e.g., based on user input, rules, other stored data, etc.).

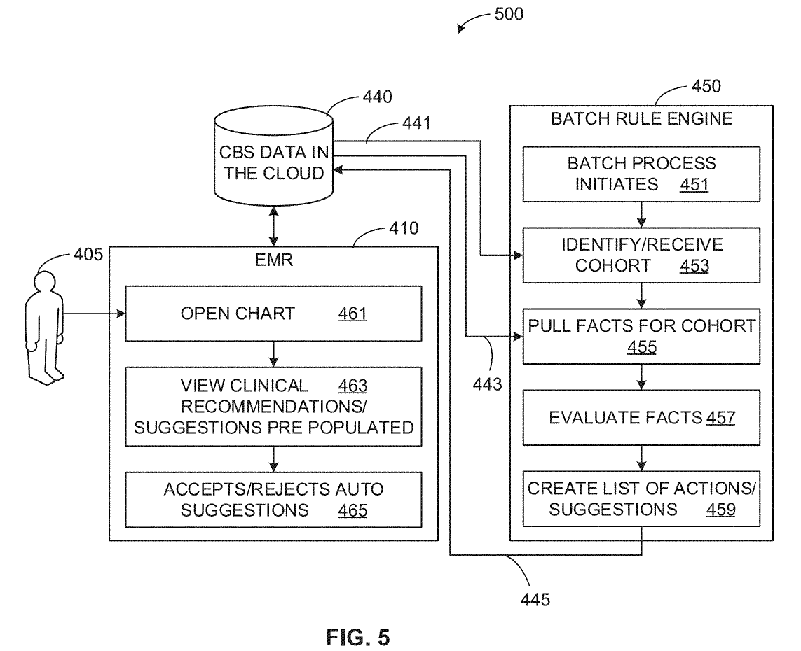

FIG. 5 illustrates an example system 500 in which the EMR 410 works with a cloud database 440 and a batch rule engine 450. As shown in the example of FIG. 5, the physician 405 opens a chart 461 via the EMR 410. Patient data is retrieved from and/or provided to the cloud database 440. The cloud-based data 440 is batched as a cohort 441 and provided to the batch rule engine 450. In the batch rule engine 450, a batch process initiates 451 and the cohort 441 is identified and/or received 453. The batch rule engine 450 pulls 455 facts 443 from the database 440 based on the cohort 441 and evaluates 457 the facts 443 with respect to rules of the batch rule engine 450. The batch rule engine 450 generates 459 a list of actions and/or suggestions provided as a response 445 to the cloud database 440 based on the actions and/or suggestions. The EMR 410 can query the cloud database 440 to view pre-populated clinical recommendations and/or suggestions 463 in real time and/or substantially real time given data retrieval, processing, and/or transmission delay. The EMR 410 accepts and/or rejects 465 the automatically generated recommendations and/or suggestions (e.g., based on user input, rules, other stored data, etc.).

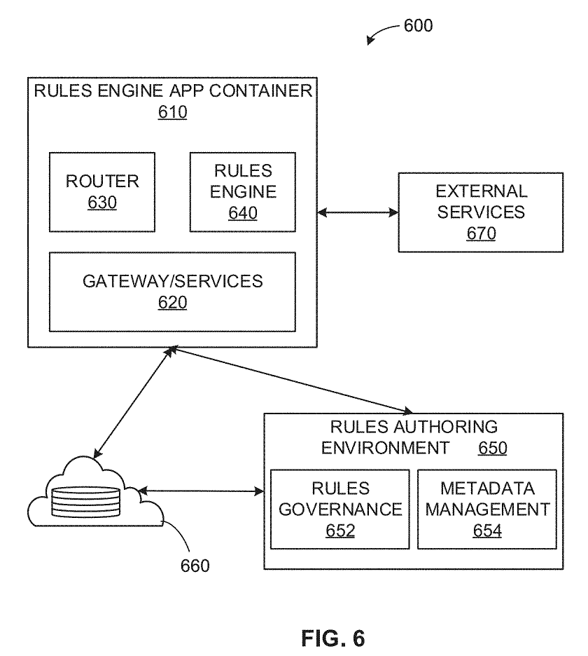

FIG. 6 illustrates an example rules engine application container 610 including a gateway/services 620, a router 630, and a rules engine 640 (e.g., the rules engine 420, rules engine 450, and/or other rules engine, etc.). The example gateway and/or other communication services 620 includes one or more end points, Representational State Transfer (REST) architecture with JavaScript Object Notation (JSON) for data interchange, discovery, audit, logging, security, monitoring, etc. The gateway services 620 provides a point of entry for rules engine 640 requests. An application program interface (API) for the rules engine 640 is exposed for access, such as via a REST endpoint over HTTPS, etc. An input and output payload can be implemented using a data model, such as a data model from the Fast Healthcare Interoperability Resources (FHIR) Draft Standard for Trial Use (DTSU 2) Specification. The gateway services 620 are responsible for cross-cutting functions such as logging, security, auditing, etc.

The example router 630 includes a rules set selector, rules metadata template(s), mapping, etc. The example rules engine 640 provides execution of rules according to a rule set/policy, for example. In certain examples, the router 630 fetches pre-requisite data for rule execution, validate clinical facts, and provide data and facts to the rules engine 640 to generate a recommendation. Once the rules engine 640 provides the recommendation, the router 630 post-processes the data before providing the data to the gateway server 620.

The example rules engine application container 610 interacts with a rules authoring environment 650. The example rules authoring environment 650 includes rules governance 652 and metadata management 654, for example. Rules can be stored in a storage 660, for example. The example rules engine application container 610 also interacts with one or more external services 670 such as a terminology service, fact provider service, and/or other rules, workflow and/or event providing service (e.g., Drools engine, etc.).

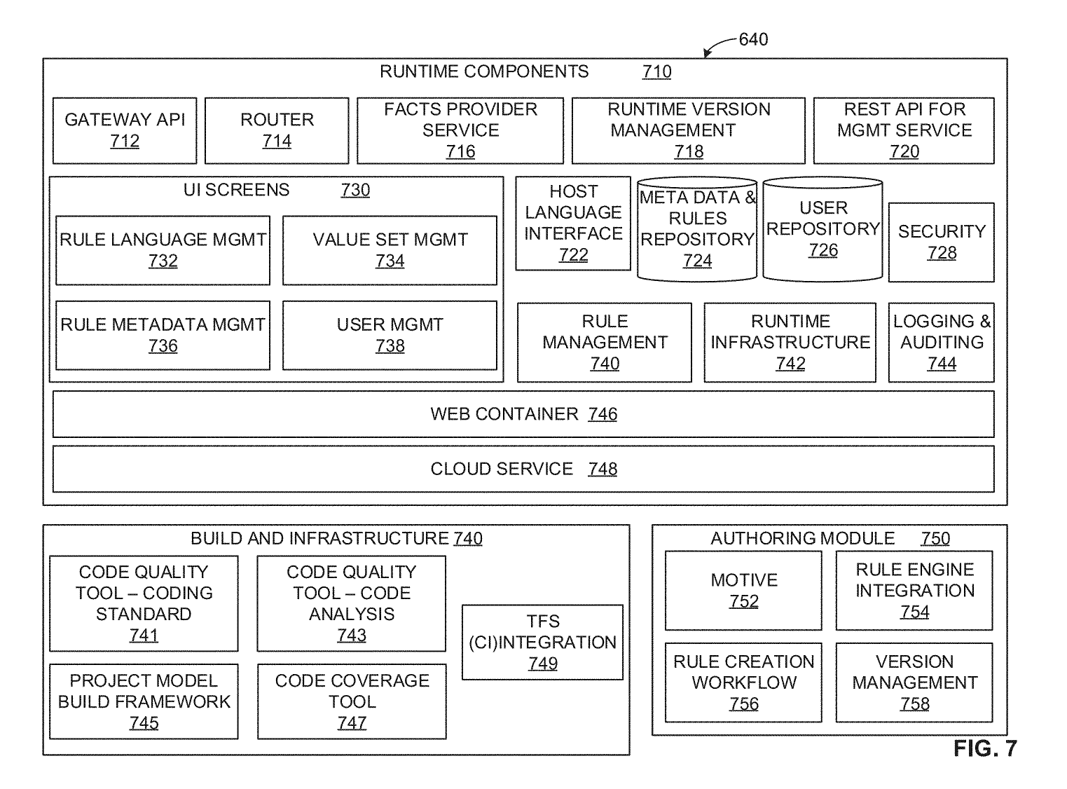

FIG. 7 illustrates an example implementation of the rules engine 640. The example engine 640 includes a plurality of runtime components 710. Example components 710 include a gateway API 712, a router 714, a facts provider service 716, runtime version management 718, and a REST API for management service 720. These components facilitate data and instruction exchange to generate rules.

Example runtime components 710 can also include a host language interface 722, a metadata and rules repository 724, a user repository 726, and security 728. Thus, an incoming request, instruction, data, etc., can be interpreted, verified/authenticated, combined with metadata, etc. Additionally, the runtime components 710 can include one or more user interface screens 730 to generate graphical user interface (GUI) displays to show information and accept input such as rule language management 732, value set management 734, rule metadata management 736, and user management 738, etc. Example runtime components 710 can also include rule management 740, runtime infrastructure 742, and logging and auditing 744, etc., to provide resources to manage, execute, and monitor execution of rules, for example. The example runtime components 710 also includes a web container 746, and a cloud service 748 to store, share, and decentralize access to the rules engine 640.

The example runtime engine 640 also includes build and infrastructure components 740. The example build and infrastructure components 740 include a code quality tool for coding standard 741, a code quality tool for code analysis 743, an object model build framework 745, a code coverage tool 747, and a Team Foundation Server Continuous Integration (TFS (CI)integration) 749. The example build and infrastructure components 740 provide tools to evaluate, track, and correct quality of code forming a rule. Continuous integration is the process of generating a build when a programmer checks code into source code control.

The example runtime engine 640 also includes an authoring module 750. The example authoring module 750 includes a motive 752, a rule engine integration 754, a rule creation workflow 756, and version management 758. Using the example authoring module 750, a rule can be generated according to a workflow 756 with an associated motive 752 and version management 758 and integrated 754 with other rule(s), information, action, etc., for example.

In an example, a rule is generated via the authoring module 750 and tested and codified for execution by the build and infrastructure 740. The executable rule is then stored in the web container 746 and made available via the cloud service 748. The user interface screens 730 provide visibility to the rule, which can be accessed and/or otherwise deployed via the gateway API 712 and router 714 in conjunction with facts from the facts provider service 716 and other support and management components 718-744, for example.

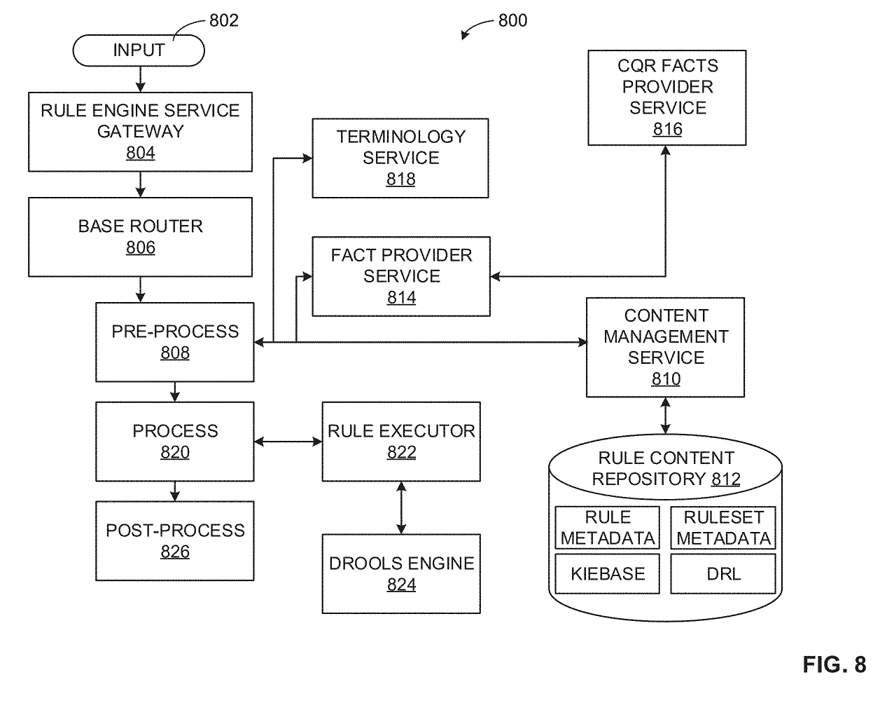

FIG. 8 illustrates a flow diagram of an example rules engine execution flow 800 among rules engine 640 components to build and execute a rule for a given input. At block 802, an input is provided to the rules engine 640 to generate an output. The example input 802 can include one or more of a rule set identifier, a tenant identifier, a specialty identifier, a user identifier, an “as of” date, fact(s), etc. The generated output can include a list of actions, for example. A rule engine service gateway 804 provides the input 802 to a base router 806.

At block 808, the data is pre-processed. For example, the input 802 can be processed with a fact provider service 814 to verify and/or supplement fact(s) provided in the input and/or provide fact(s) (e.g., from a Clinical Quality Reporting (CQR) fact provider service 816, etc.) in response to identifier(s) provided in the input. A terminology service 818 provides and/or adjusts proper terminology for a rule in accordance with the fact(s) and/or identifier(s) provided in the input 802. Pre-processing 808 can also include accessing a rule content repository 812 via a content management service 810. The example rule content repository 812 includes rule metadata, ruleset metadata, a Drools rule language (DRL) core, Kiebase and/or other application knowledge definition repository, etc.

Retrieved rule, fact, and/or terminology information is provided with the input 802 for processing at block 822. During processing 822, a rule executor 822 calls a rules execution engine such as a Drools engine 824 to execute the rule based on provided fact(s), identifier(s), metadata, etc. The result is provided for post-processing at block 826 (e.g., to clean up, frame, present, and/or otherwise prepare result(s) for output, etc.).

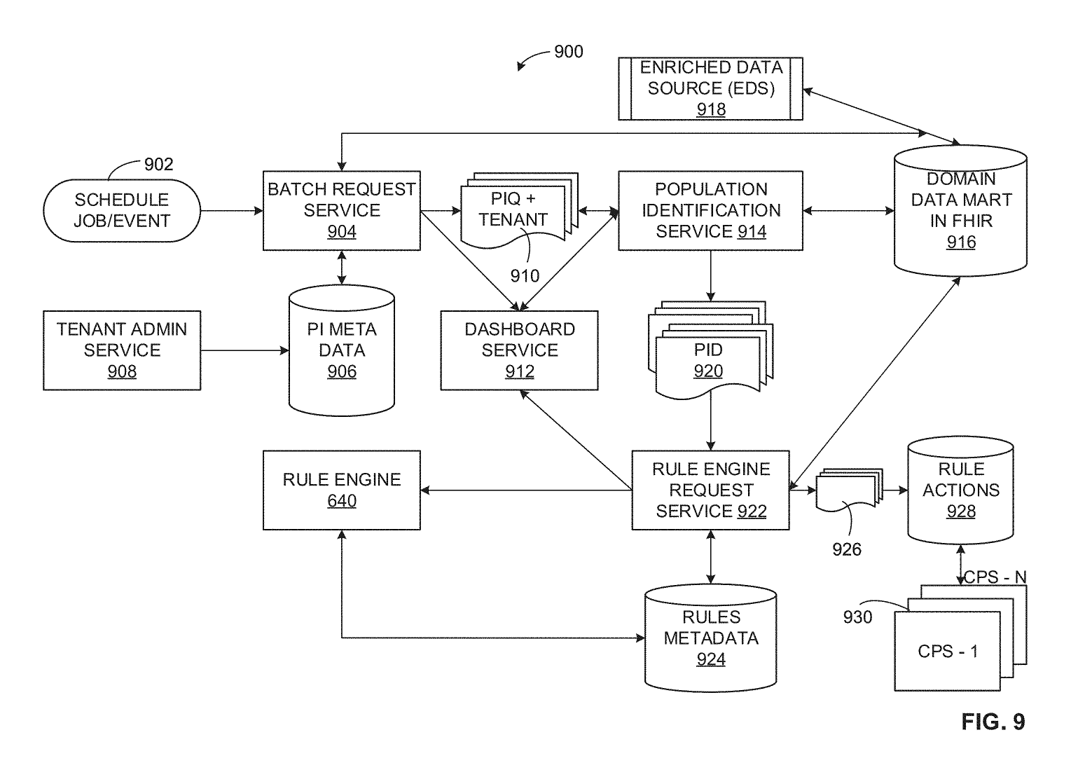

FIG. 9 illustrates a flow diagram of an example method 900 for a batch process flow to provide recommendation and/or other data to a clinician based on patient history and facts. For example, the batch process for clinical decision support helps in analyzing thousands of patients during a non-peak time to generate recommendations in advance of a physician-patient encounter. Services included in the batch flow help provide a workflow to identify patients, executed rules, and persist recommendations.

At block 902, a job or event is scheduled based on a trigger generated from an update of domain data. The scheduled job/event is provided to a batch request service 904 with associated metadata for a given tenant (e.g., user, job, event, etc.). The batch request service 904 communicates with patient identifier metadata 906. A tenant administrator service 908 works with the patient identifier metadata 906 to generate a configuration for each tenant. The configuration includes metadata 906 such as tenant, patient identification and qualification (PIQ), ruleset, etc.

In certain examples, the batch flow is provided via a cloud-based application to service hundreds of tenants such as hospitals, ambulatory care centers, etc. For each tenant, a PIQ message is placed in a Patient Identifier Request (PIR) queue 910 with a tenant identifier, which can be used by downstream components for further processing. Information can also be provided to a dashboard service 912 for analysis and display.

The PIR is provided from the queue 910 to a population identification service 914. The population identification service 914 can be implemented, for example, as a REST service that can be invoked by another service, component, etc. The population identification service 914 watches the PIR queue 910 and processes received messages. For each tenant, the service 914 identifies patients (e.g., all patients or a subset created using a filter criterion to select patients based on appointment date, age, other criterion, etc.), and an individual message is created and placed in the rule execution queue 920.

Thus, the population identification service 914 constructs a query and pulls a patient identifier (PID) from a domain data mart 916 (e.g., a Fast Health Interoperability Resources (FHIR) domain data mart, etc.) which includes patient data from one or more enriched data sources (EDS) 918, for example. In certain examples, the data mart 916 runs with a patient FHIR service to provide patient information in the FHIR model. The population identification service 914 can use the FHRI model and associated service to fetch details for a patient. After retrieval, the population identification service 914 places the PID into a rule execution request queue 920.

For example, once the request is successfully processed, an entry is made on a service bus based PIR queue 920. The rule engine request service 922 pulls a message from the rule execution queue 920 and extracts metadata from a rules metadata 924. The request service 922 creates an input from the PID and metadata and facts retrieved from the data store 916. The request service 922 provides the input to the rules engine 640. The rules to be run as part of the batch process can be configured using property settings, for example. Rules can be tenant-specific, tenant-agnostic, etc.

For each identified patient, patient facts are pulled from an external repository 916 and then fed to the rules engine 640. The rules engine processes the data and provides one or more recommendations, which is/are then persisted via a rules result service 926. The rules result/action service 926 persists recommended actions based on execution of the rule with respect to the patient. The service 926 persists or stores recommended actions(s) as records 930 in a rules results repository 928. In certain examples, the recommendations are split into single actions so that independent processing can be performed against each action. If there are no recommendations are provided in the rules response, a record 930 with an empty action can be persisted, for example.

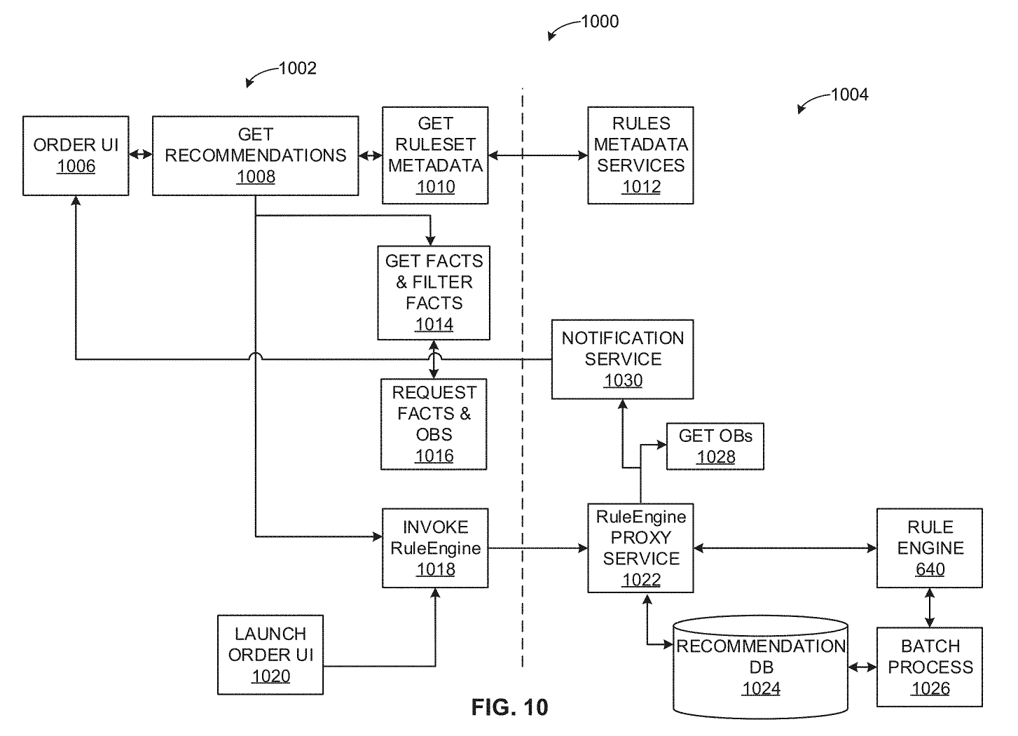

In certain examples, the rules engine 640 works with and/or is integrated with a clinical practice management system and/or other healthcare information system. As shown in the example system 1000 of FIG. 10, the rules engine 640 can be located in the cloud 1002 and interact with a local, on-premise information system 1004.

At block 1006, an order user interface (UI) can be used to add a problem (e.g., associated with a patient) via the on-premise information system 1002 (e.g., a practice management system, electronic medical record, etc.). At block 1008, recommendation(s) for rule formation are retrieved from the information system 1002. At block 1010, ruleset metadata is retrieved. After retrieving the ruleset metadata, the ruleset is provided to a rules metadata services 1012 in the cloud 1004.

At block 1014, facts are requested and filtered. For example, patient information and/or other facts relating to rules are requested and filtered according to patient, ruleset relevance, etc. At block 1016, facts and observations are requested and retrieved (e.g., from the on-premise information system 1002) for filtering at block 1014. At block 1018, the rule engine 640 is invoked using the facts and rules. At block 1020, the order UI can be launched asynchronously to invoke the rule engine 640 (block 1018) and batch recommendation via the on-premise information system 1002, for example.

At block 1022, a proxy service for the rule engine 640 facilitates invocation of the rule engine 640 via the cloud 1004. The proxy service accesses a recommendation database 1024 and batch process 1026 in conjunction with the rule engine 640. The rule engine 640 provides a recommendation in the recommendation database 1024 for one or more rulesets and facts via the batch process 1026. The proxy service 1022 can retrieve observation information 1028 and leverage a notification service 1030 to provide an output via the user interface 1006.

Thus, patient facts can be made available in the on-premise information system 1002 (e.g., practice management system client cache, etc.) and can be filtered. Requests and recommendations can be batched and executed with the rule engine 640 via the cloud 1004 to generate a notification for user(s) generating an order for a patient (e.g., including users who have navigated away from the order screen, etc.).

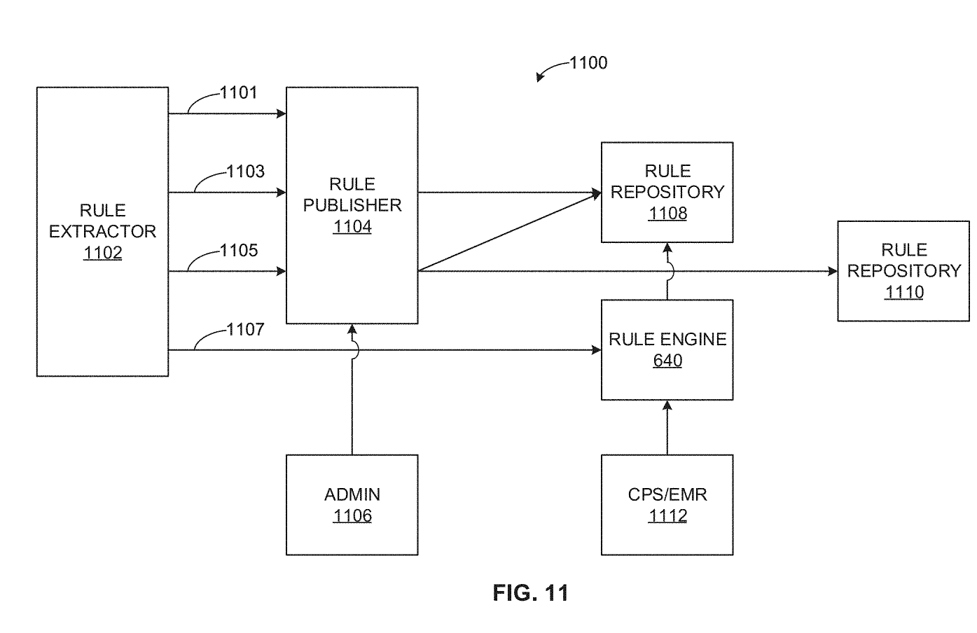

FIG. 11 illustrates an example testing and production environment 1100 for rules drafting, testing, and production using a rule extractor 1102, a rule publisher 1104, administrator 1106, rule repositories 1108, 1110, clinical practice solution (CPS)/EMR system 1112, and rule engine 640. The rule extractor 1102 extracts a draft rule, and, at 1101, the draft rule is published via the rule publisher 1104. Publishing a ruleset and associated rules (e.g., in a staging event, etc.) is a two-stage process involving publication via the rule publisher 1104 and tent-specific provisioned database in the form of the rule repository 1108 (e.g., service and data, etc.). In certain examples, data is pulled from the rule publisher 1104 to the rule repository 1108. The rule engine 640 is invoked 1107 to test the published ruleset and rule(s) in the rule repository 1108 (e.g., for the published tenant) in conjunction with the CPS/EMR 1112.

At 1103, the draft rule (e.g., modified by the testing from the rule engine 640, etc.) is approved and re-published via the rule publisher 1104 to the rule repository 1108. After testing determines that the rule and ruleset are satisfactory (e.g., meet a standard, a threshold, approval, etc.), the draft is deleted 1105 and pushed to the rule repository 1110 to production. In certain examples, the administrator 1106 can trigger the rule publisher 1104 to productionize the ruleset and rule based on the testing with the EMR and/or other management application 112. Once in production, the rule and ruleset are available in the repository 1110 for use by the rule engine 640 and/or others.

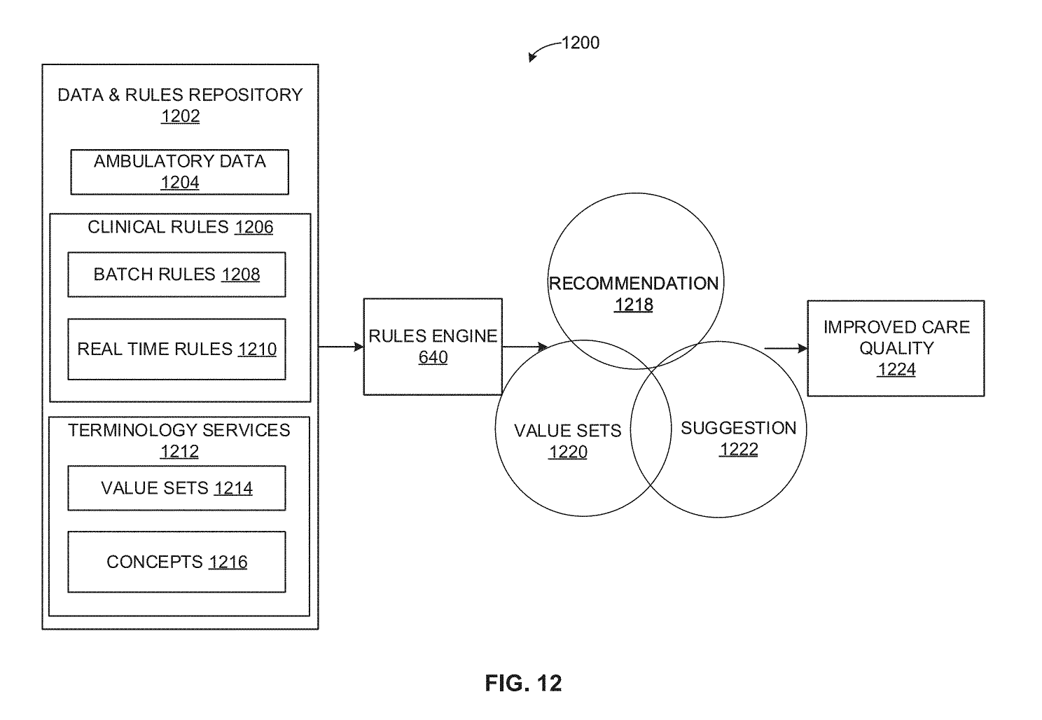

FIG. 12 illustrates an example clinical decision support system 1200 including a data and rules repository 1202. The example repository 1202 includes ambulatory data 1204, clinical rules 1206, and terminology services 1212. The example ambulatory data 1204 includes information such as patient identifier, procedure identifier, order, observation, medication order, medication, immunization, care goal, family history, encounter, problem, allergy intolerance, etc. The rules engine 640 leverages the ambulatory data 1204 using rules 1206 and terminology services 1212. The example clinical rules 1206 include batch rules 1208 and real time rules 1210 (see, e.g., the description of FIGS. 4-10). The example terminology services 1212 includes value set(s) 1214 and concept(s) 1216 to support the interpretation of data 1204 according to the rules 1206 by the rules engine 640, for example. The rules engine 640 generates a recommendation 1218, a value set 1220, and/or a suggestion 1222 to facilitate improved care quality 1224.

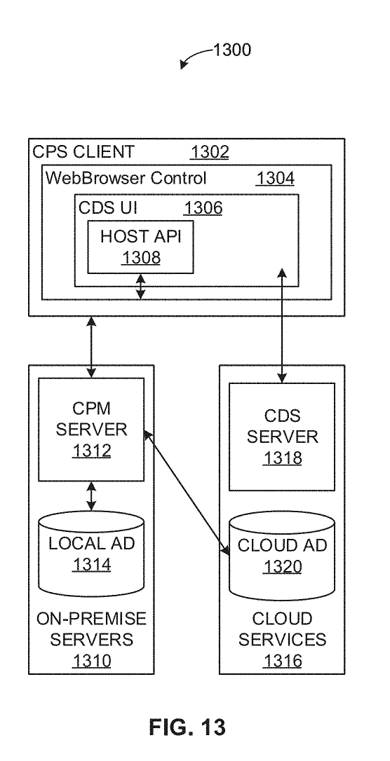

In certain examples, the rules engine 640 and associated repository 1202 can be embedded in one or more other clinical applications 1300. For example, as shown in FIG. 13, a CPS client 1302 includes a web browser control 1304, a clinical decision support (CDS) user interface 1306, and a host API 1308. The CPS client 1302 communicates with one or more on-premise servers 1310 and one or more cloud-based and/or otherwise remote servers 1316. Each on-premise server 1310 includes a clinical practice management (CPM) server 1312 and a local active directory (AD) 1314. Each cloud-based server 1316 includes a clinical decision support (CDS) server 1318 and a cloud AD 1320. The cloud AD 1320 can provide information to the CPM server 1312, for example.

Thus, a user logs in via the CPS client 1302, and the CPM server 1312 can authenticate the user via the local AD 1314 as well as the cloud AD 1320. The user invokes orders, and the CPM server 1312 loads the clinical decision support 1318 address (e.g., uniform resource locator (URL), etc.) in the Web Browser control 1304 for interaction via the UI 1306. The rules engine 640 and repository can be leveraged by the user from the CDS server 1318 via the UI 1306, for example.

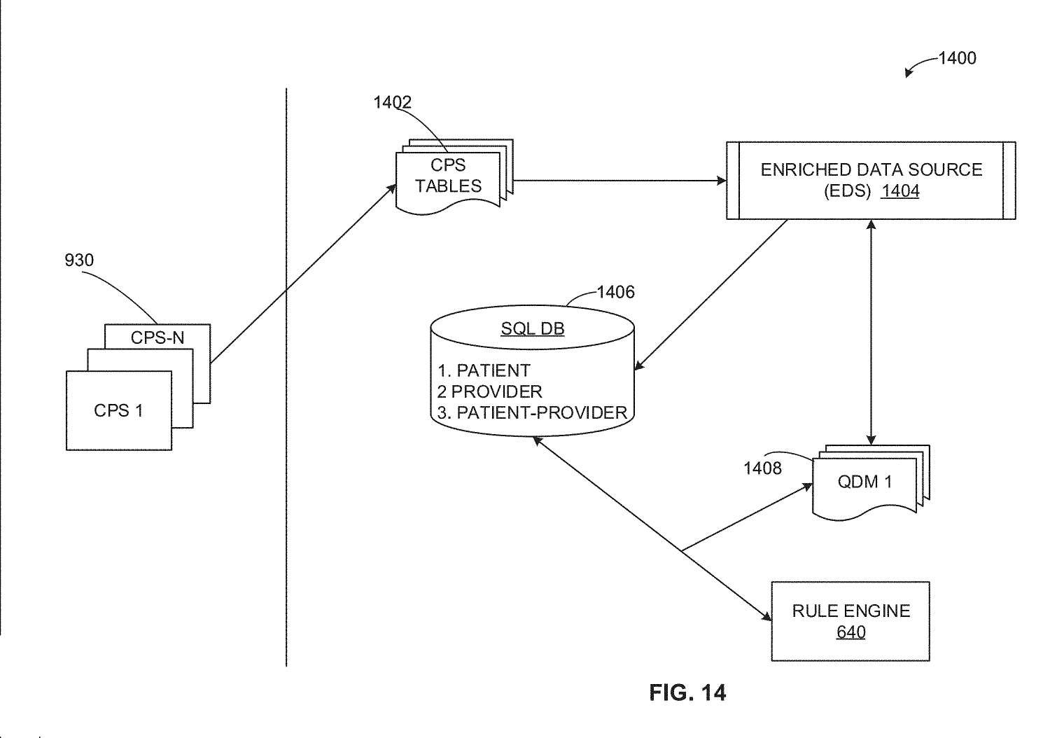

FIG. 14 provides a data flow 1400 for clinical quality reporting (CQR) using the rule engine 640. As shown in the example of FIG. 14, data is moved from one or more on-premise CPS 930 to one or more CPS tables 1402 located in the cloud via an application development framework (ADF), for example. Enriched data is created with standard codes and provided from the CPS table(s) 1402 to an enriched data source (EDS) 1404. Enriched data in the EDS 1404 can be formed using term mapping and can be partitioned by patient identifier, tenant, etc. The EDS 1404 can be implemented in a data warehouse system such as a Hive data warehouse, etc., with data organized according to one or more quality data models (QDM), for example.

Enriched data can be executed from the EDS 1404 to a database 1406, such as a structured query language (SQL) database 1406 according to patient, provider, and patient-provider information (e.g., using one or more SQL tables to identify patients, etc.). Additionally, a patient longitudinal health record (LHR) can be formed from QDMs 1408 of enriched patient data from the EDS 1404. In certain examples, the database 1406 can be queried to identify patient(s), and corresponding patient data can be pulled from the QDM 1408. The rule engine 640 is invoked for each patient QDM 1408 to process patient data according to rule(s) to generate a clinical quality report, for example.

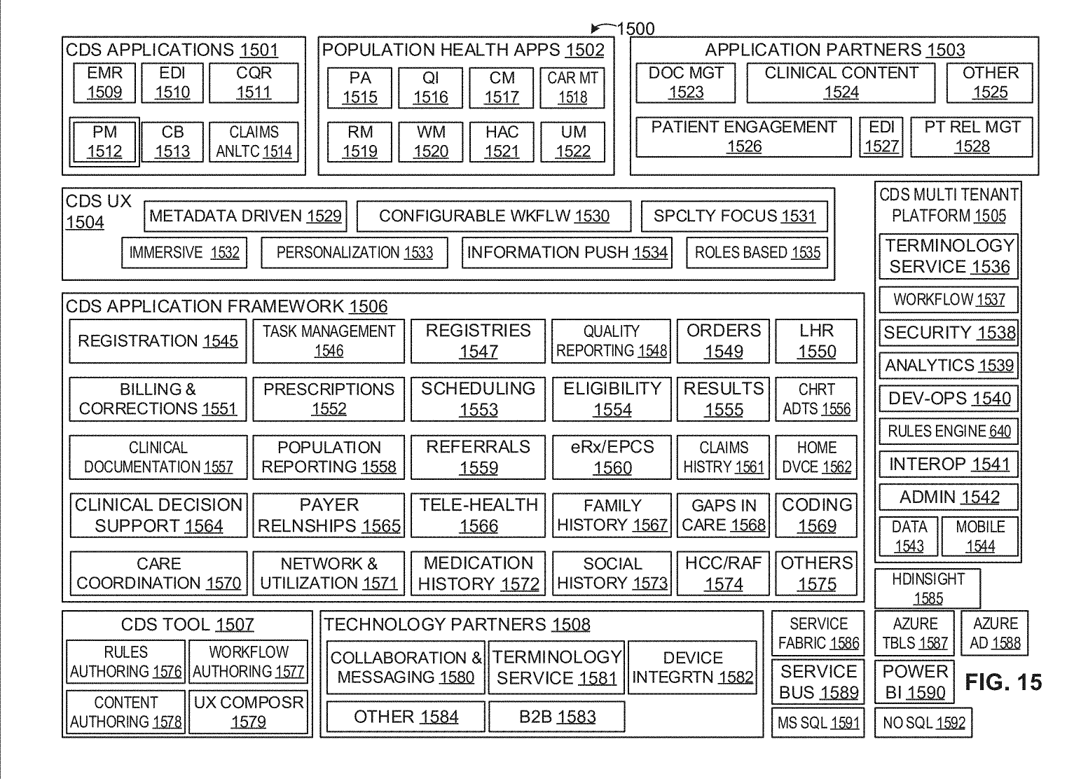

FIG. 15 illustrates an architectural block diagram of an example clinical decision support (CDS) system 1500 including the rules engine 640. The example CDS system 1500 includes CDS applications 1501, population health applications 1502, partner applications 1503, CDS user experience (UX) 1504, a CDS multi-tenant platform 1505, a CDS application framework 1506, CDS tools 1507, technology partners 1508, etc.

More particularly, as shown in the example of FIG. 15, CDS applications 1501 can include an EMR 1509, electronic data interchange (EDI) 1510, CQR 1511, practice management (PM) 1512, clinical business (CB) 1513, claims analytics (e.g., GE Denials-IQ™, etc.) etc. Population health applications 1502 can include patient-provider assignment (PA) 1515, quality improvement (QI) 1516, care management (CM) 1517, care management 1518, risk management (RM) 1519, patient wellness management (WM) 1520, hospital acquired condition (HAC) 1521, utilization management (UM) 1522. Other partner applications 1503 can include document management 1523, clinical content 1524, other content 1525, patient engagement 1526, EDI 1527, patient relationship management 1528, etc.

Additionally, as shown in the example of FIG. 15, CDS UX 1504 components can include a metadata driven UX component 1529, a configurable workflow 1530, a specialty focus UX component 1531, an immersive UX component 1532, a personalization component 1533, an information push component 1534, a role-based UX component 1535, etc. The example CDS multi-tenant platform 1505 can include a terminology service 1536, a workflow engine 1537, a security component 1538, analytics 1539, a development and operations (dev-ops) component 1540, the rules engine 640, an interoperability component 1541, an administrator 1542, a data component 1543, a mobile component 1544, etc.

In the example of FIG. 15, the CDS application framework 1506 can include registration 1545, task management 1546, registries 1547, quality reporting (QR) 1548, orders 1549, longitudinal health record (LHR) 1550, billing and corrections 1551, prescriptions 1552, scheduling 1553, eligibility 1554, results 1555, chart audits 1556, clinical documentation 1557, population reporting 1558, referrals 1559, electronic prescriptions (eRx)/electronic prescriptions for controlled sub stances (EPCS) 1560, claims history 1561, home device 1562, clinical decision support (CDS) 1564, payer relationships 1565, tele-health 1566, family history 1567, gaps in care 1568, coding 1569, care coordination 1570, network and utilization 1571, medication history 1572, social history 1573, hierarchical condition category (HCC)/risk adjustment factor (RAF) 1574, other 1575.

In the example of FIG. 15, the CDS tools 1507 can include a rules authoring tool 1576, a workflow authoring tool 1577, a content authoring tool 1578, a UX composer tool 1579, etc. Technology partners 1508 can include collaboration and messaging 1580, a terminology service 1581, device integration 1582, business-to-business (B2B) transaction component 1583, and/or other component 1584, for example. Other components in the example system 1500 include a service fabric 1586, cloud (e.g., Microsoft Azure™, etc.) tables 1587, cloud active directory 1588, a service bus 1589, business analytics (e.g., Microsoft Power BI, etc.) 1590, data server (e.g., Microsoft SQL server, etc.) 1591, non-relational database 1592 (e.g., NoSQL, etc.), etc. Thus, the rules engine 640 can be used with a variety of applications 1501, 1502, 1503, 1506, 1508 as well as authoring tools 1507 and user interface components 1504 to provide rules-based application services to a user.

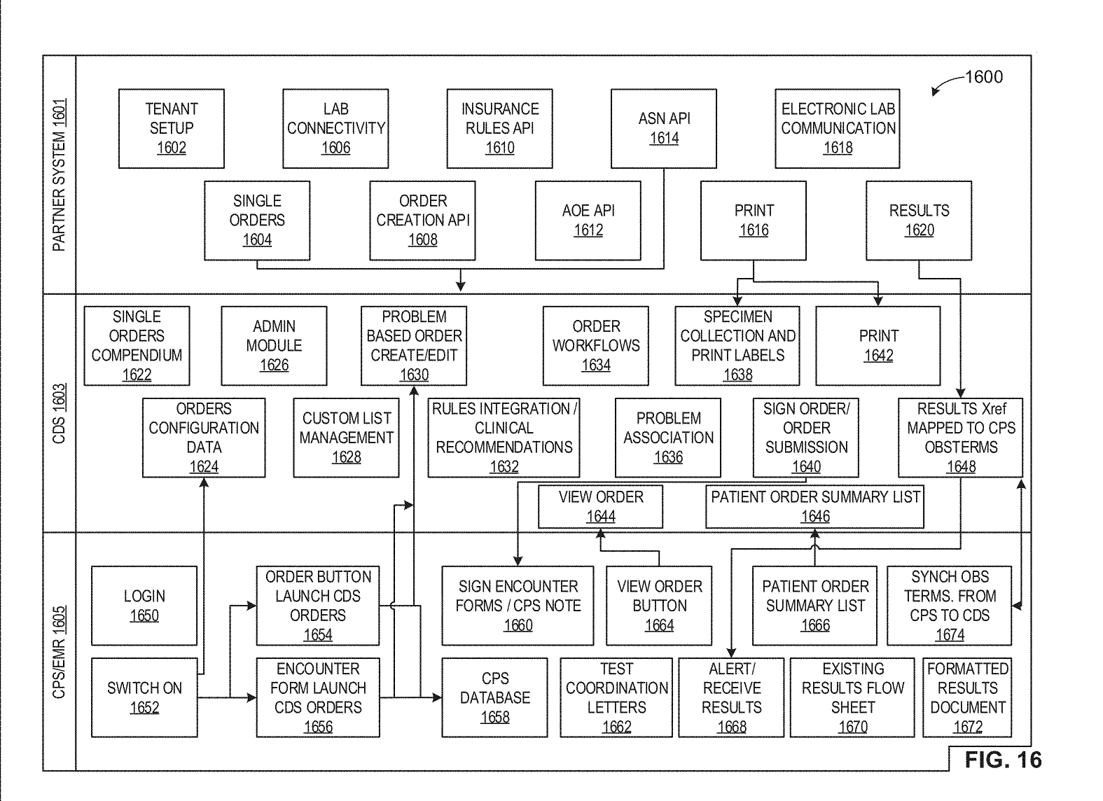

FIG. 16 illustrates another example block diagram of a system 1600 integrating a partner system 1601 with a CDS 1603 and CPS/EMR 1605. As shown in the example of FIG. 16, the partner system 1601 can provide one or more API, communication, etc., to interface with the CDS 1603 which interfaces with the CPS/EMR 1605 to leverage stored clinical information and rules to deliver application functionality to a user.

As shown in the example of FIG. 16, partner system 1601 components such as tenant setup 1602, single orders 1604, lab connectivity 1606, order creation API 1608, insurance rules API 1610, Ask at Order Entry (AOE) API 1612, abstract syntax notation (ASN) API 1614, print component 1616, electronic lab communication 1618, results 1620, etc. Order(s) 1604 can be provided to the CDS 1603 for rules-based processing.

For example, the CDS 1603 provides a single orders compendium 1622 to receive the single order 1604. Order configuration data 1624 provides order configuration information to the administrative module 1626 and custom list management 1628. The CDS 1603 provide problem-based order creation and/or editing 1630 as well as rules integration/clinical recommendation 1632. The rules integration/clinical recommendation component 1632 can include the rules engine 640 and its associated repository, terminology services, etc., for example. The CDS 1603 also provide order workflows 1634 and problem association 1636. The CDS 1603 includes specimen collection and print labels 1638 and print component 1642 to interact with the print component 1616 of the partner system 1600. An order signature/order submission component 1640 interacts with the CPS/EMR 1605 to submit an order. The order can be viewed 1644 and a patient order summary list 1646 can be provided. The results 1620 from the partner system 1601 are cross-referenced and mapping to observation terms at the CPS/EMR 1605 via the mapper 1648 of the CDS 1603.

As shown in the example of FIG. 16, the CPS/EMR 1605 provides a login 1650 and switch on or activator 1652 to access order configuration data 1624 from the CDS 1603 and/or launch CDS orders via an order button 1654 and/or encounter form 1656. Order(s) are provided to a CPS database 1658. The sign order/order submission 1640 at the CDS 1603 communicates with an encounter form/note sign component 1660 at the CPS/EMR 1605. Test coordination letter(s) 1662 can be generated by the CPS/EMR 1605. The CPS/EMR 1605 can provide a view order button 1664 for a user to view order(s) 1644 stored at the CDS 1603. A patient order summary list 1666 can be provided by the CPS/EMR 1605 to the patient order summary list 1646 of the CDS 1603. The CPS/EMR 1605 can communicate with the mapper 1648 of the CDS 1603 to generate an alert/receive results 1668, for example. Results can be used to generate a flow sheet 1670. The flowsheet 1670 can be used to generate a formatted results document 1672. Observation terms can be synchronized 1674 between the mapper 1648 at the CDS 1603 and the CPS/EMR 1605.

Thus, certain examples provide systems and methods for workflow rules to drive automation for an Electronic Medical Record (EMR) system through use of tasking, alerts, suggestions, etc. Certain examples facilitate completion of various portions of medical practice activities (e.g., management, registration, rooming, encounter, visit summary, billing, etc.) through facilitation of the workflow to eliminate manual processes. Certain examples provide a role-based rules system to determine access, tasks, alerts and suggestions to be presented to complete medical practice activities. In certain examples, the system also allows for both role-based rules and individual custom rules to be created. Certain examples drive web page and/or other interface content navigation to complete tasks.

Using the rules engine 640, for example, provider input and/or one or more triggers can activate the rules engine 640 to apply productive analytics. An example of such analytics is as follows: Suppose a patient is over the age of 13; the rules engine 640 can advise a provider to inquire whether the patient smokes. Such alerting and proactive suggestion for provider-patient encounter interaction, diagnosis, and/or treatment can be extrapolated into more complex conditions such as cancers and/or other inherited conditions. For example, if the patient has a documented family history, the rules engine 640 can advise the provider to inquire further and advise productive procedures such as a mammogram for breast cancer. Analytics, such as meaningful use (MU), clinic-specific, custom, etc., can be built, executed, and maintained in conjunction with the rules engine 640 to provide clinical decision support.

Providers have a limited amount of time and cognitive energy. By providing a solution that decreases the amount of cognitive load and time required for initial and mundane diagnostics, providers can instead exert their cognitive energy on more complex conditions. Additionally, patient outcome can be improved by intervening earlier in the patient care cycle. Certain examples enable a provider to provide benchmark goals to the patient to prevent worsening of a condition and improve overall health while decreasing medical cost over the patient's life time.

Certain examples, increase medical evidence if a patient does not comply with preventive measures. Insurance claims can become more accurate due to greater and more complete sets of monitored information.

In certain examples, machine learning technologies (e.g., convolutional neural network, deep learning network, feature-based machine learning, etc.) can be applied to unlabeled patient data in one or more specified subject areas such as smoking, drinking, etc. The system can apply the machine learning to determine points of intervention between the provider and his or her patient.

In operation, in certain examples, the rules engine 640 executes against patient facts and type of appointment scheduled. The clinical decision support system packages results as tasks, activities and/or order recommendations to end users for next steps in patient care (e.g., in a patient care plan or pathway, etc.).

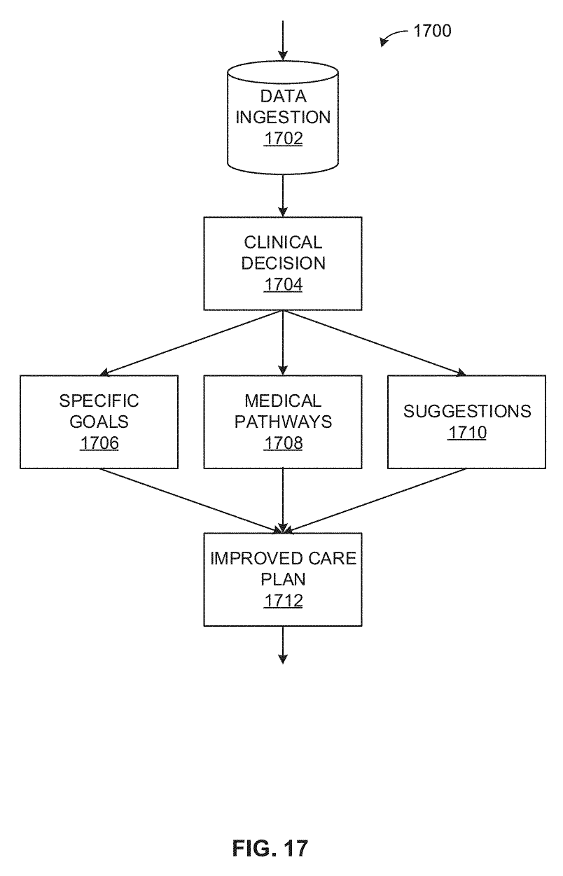

Thus, as shown in the example of FIG. 17, a clinical decision support system 1700 can leverage the rules engine 640 as part of the clinical decision support to generate an improved patient outcome. As shown in the example of FIG. 17, data ingestion 1702 receives and processes (e.g., formats, normalizes, validates, etc.) incoming data such as patient data, purpose/reason for examination, lab results, etc. Clinical decision support 1704 processes the ingested data based on one or more rules, repository information, etc., to generate one or more specific goals 1706, medical pathways 1708, and/or other suggestions 1710 for the patient. The goal(s) 1706, pathway(s) 1708, and/or suggestion(s) 1710 are used to generate an improved care plan 1712 for the patient.

In certain examples, clinical decision support 1704 can involve adjustment of a rule and/or creation of a new rule via the rules engine 640 and repository based on the ingested information for the patient. Monitoring of incoming clinical data (e.g., from patient appointments, lab results, and/or other input data, etc.) can be used with respect to the rule(s) to determine whether the patient care plan 1712 is being followed to meet a specified goal 1706, for example. If the goal 1706 is not being met according to the care plan 1712, the care plan 1712 and/or goal 1706 can be adjusted, for example.

For example, suppose Alice Cooper is a 66 year old female patient who is a previously well-managed diabetic but is now diverging from her designated care pathway. Her patient record reads as follows:

### History of Patient Visits & ‘Facts’ (Data) in Patient's Record

1998/07/21—Vitals, Past Medical/Surgical/Family/Social History, Problem, Allergies & Medication added
Ht: 5′4″, Wt: 170 lbs, BP: 120/80 BMI: 29.2
PMH: Hashimoto's Thyroiditis, Obesity, Vitamin D deficiency
PSH: Cholecystectomy, Appendectomy, Breast Reduction
FH: Mother, Father, and Sister have thyroid disease; Father has type II Diabetes; Mother has polymyositis
SH: Works as a school nurse, No alcohol or cigarettes
Allergies: Compazine, Penicillin
Diagnosed with Hypothyroidism (ICD 244.9)
Synthroid 75 mcg po qd
   2008/11/29—Vitals, Problem & Medication added
Ht: 5′4″, Wt: 190 lbs, BP: 145/90
Diagnosed with Hypertension NOS (ICD 401.9)
Dyazide 37.5-25 mg po qd
   2009/04/13—Vitals, Problem & Medication added
Ht: 5′4″, Wt: 190 lbs, BP: 135/80
Diagnosed with Hyperlipidemia NEC/NOS (ICD 272.4)
LDL=142
Atorvastatin 10 mg/d
Screening mammogram completed, resulted as BIRADS 1
   2009/10/15—Vitals, Med renewals
Ht: 5′4″, Wt: 190 lbs, BP: 135/75
Patient self-discontinued dyazide, continues atorvastatin
   2010/04/11—Vitals, Problem, Medications, Lab results added
Ht: 5′4″, Wt: 195 lbs, BP: 130/80
Diagnosed with Diabetes Mellitus II (ICD 250.00)
A1c=8.2% LDL=125
Metformin 2000 mg/d started & Atorvastatin increased to 20 mg/d
Aspirin 81 mg/d

### 2014/03/11—Vitals, Lab Results

HPI: Enjoying retirement. Was having some vague leg pain several weeks ago, thought it was the statin but symptoms resolved without discontinuing the med. Recent AM FBS in 100-130 range.
Ht: 5′4″, Wt: 225 lbs, BP: 125/85
Labs: HbA1c=7.0%, LDL=79, Creatinine=1.2, eGFR=75,
DM ASSESSMENT: Doing well on current regimen with A1c at goal. Recent weight gain of some concern but patient resuming exercise regimen and starting low carb diet. To reassess in 3 months.
   2015/03/12—Gap in care reminders, analytics
DM HbA1c listed as gap in care on patient chart and physician dashboard; patient reminder sent via modality of choice, e.g. phone, letter, email, text that she is overdue for diabetes follow up visit and specifically obtaining HbA1c lab test. Patient has had a screening mammogram listed as a gap in care on her chart since 2011 (last mammogram 2009/04/13) and has been on PCP's mammogram dashboard.

After six months from her missed appointment and over one year since her last office visit, the patient returns to town after a period of absence from medical care. Having received a communication (e.g., letter, email, phone, text etc.) reminding her that she is overdue for a diabetes follow-up and Hemoglobin A1C (HbA1c) test, the patient calls her primary care provider (PCP) to schedule a follow-up appointment. A front office assistant schedules an appointment for one week later. The appointment scheduling type triggers rules (e.g., system evaluation for registration data integrity, last visit greater than one year prior, etc.), and the front office assistant receives a system reminder to prompt the patient for change in address, contact information, and insurance coverage, for example. The patient informs the office assistant of new insurance coverage (e.g., a Medicare Advantage plan), which the front office person enters into the practice management and/or EMR system. The system checks new facts for rule conditions, performs an eligibility check with new insurance information, and determines patient responsibility for the pending scheduled appointment, for example. The front office assistant informs the patient of financial responsibility due at the time of appointment.

Additionally, given the time since the patient's last visit, the patient is likely to need lab tests prior to the scheduled appointment. The scheduled appointment triggers a system process for pre-visit lab tests. The system process detects an extended time since last appointment, a missed last appointment, a diagnosis of diabetes, multiple care gaps, no recent lab results, for example. The system process creates order protocols based on rules and parameters defined by the PCP organization and submits suggested system orders (e.g., associated with care gap reminders) to the lab for HgbA1c, Fasting Blood Sugar, basic metabolic panel (BMP), and urine protein screen, and a lipid profile order is also added. Lab orders are transmitted to a lab and trigger system processes for a reminder call. The system process detects the near-term scheduled office visit and puts patient on a list for automated voice response (AVR) reminder call to obtain labs prior to the scheduled appointment.

After lab tests have been completed and returned to the clinic, the lab results trigger the rules engine 640 and/or workflow engine to generate recommendation(s) for system assessment. Additionally, the HbA1c and urine protein screen are removed from a gaps in care list for the patient. Patient lab results may be as follows, for example:
eGFR 60 (low), (rule conditions—decrease since last measurement, patient has diabetes, concerning for diabetic nephropathy)
U microalbumin 90 mg/gCr (elevated) (rule conditions—new since last measurement, patient has diabetes and decreased eGFR, concerning for diabetic nephropathy, not on ACEi or ARB, consider ACEi or ARB therapy)
LDL 110 (high) (rule conditions—diabetic, on atorvastatin, consider therapy optimization)
HgbA1c 8.4% (above goal target) (rule conditions—diabetic, on metformin, consider therapy optimization)

The system notifies the PCP of abnormal lab results via tasking, and the system correlates a problem to the upcoming scheduled appointment. The provider reviews and “signs off” on the results with a desire to follow the results. Based on the desire to follow the results, the system creates an activity to review labs at the upcoming appointment (e.g., “DM management next visit.”, etc.). The system process detects the scheduled appointment, and, based on rule conditions, puts the patient on a list for an AVR reminder call about scheduled appointment. The patient receives an automated reminder and acknowledges an intent to keep the appointment. The system process runs batches to check facts against rule conditions and produces accumulated recommendations that trigger activities, tasks and/or workflows such as:
Wellness Care plan gaps
   Hepatitis C screening
   Pneumococcal polysaccharide vaccine& pneumococcal conjugate vaccine—each once after age 65
   Influenza vaccine—annual
   Screening mammogram
   Wellness exam with prevention screening and counseling—annual
Diabetes2 Care Plan gaps
   HgbA1c—every 12 months for patient at goal<7.0% —(system recognizes as obtained pre-visit)
   Diabetic foot exam—annual
   Diabetic eye exam—annual (q2 years if normal on the prior year)
   Urine protein screen—annual (system recognizes as lab results obtained pre-visit)

The patient then arrives at the PCP office for the scheduled appointment. The front office assistant greets the patient and re-verifies address, contact, and insurance coverage information and scans a current copy of the insurance card, for example. The front office assistant marks the appointment status as “arrived”. The system process runs real-time and/or in the background to execute rules the trigger tasks, activities and/or workflow for medical assistant, equipment, and/or other staff. In the waiting room, patient fills out a questionnaire about her health/symptoms. For example, the patient denies having any of the symptoms listed on the questionnaire. \

The medical assistant is busy getting an exam room ready after prior use and receives the system status notification of patient “arrived”. The system prompt motivates the medical assistant (MA) to access a system display to retrieve the identity of the waiting “arrived” patient. In addition to patient identity, the MA notes listed care gaps, chief complaint/reason for visit, and visit type (e.g., follow-up (f/u), etc.), for example. The MA retrieves the patient from the waiting room, greets the patient by name and escorts the patient from the waiting room into an exam room area for measurement of vital signs. The MA applies an arm cuff that automatically captures blood pressure (BP) and pulse, while the MA observes the respiratory rate. As the BP is captured, the system assesses the BP value as mildly elevated (e.g., 145/92). A task, activity and/or workflow is generated for provider review (e.g., the system recognizes BP is above upper target level of 140/80, etc.). While entering the respiratory rate, the MA observes a system task, activity and/or workflow reminder to measure and enter patient weight (e.g., rule conditions—diabetic, history of elevated body mass index (BMI), no weight measurement in past one year, etc.). The MA enters patient weight and system calculates an updated BMI utilizing a previous height measurement. The weight and BMI values trigger a system assessment of new facts (e.g., rule conditions—diabetic, BMI 41.7, exceeds goal [<25]), for example. With patient consent, the MA selects system recommended orders for Prevnar™ and influenza vaccine. The MA marks the patient's encounter status as “roomed,” and the patient's room location is automatically captured from the MA's location of activity.

The provider enters the exam room with the patient and greets her. The provider reviews problems recommended for today's visit. These are existing problems and recommended problems to add based on facts in the system, for example:
Diabetes Mellitus, uncontrolled (suggested by system because of HgbA1c above target);
Hypertension, uncontrolled (suggested by system because of elevated BP);
CKD/diabetic nephropathy (suggested by system because of low eGFR and elevated microalbumin);
hyperlipidemia (suggested by system because of high LDL)

The provider enters exam information into the history of present illness, and the system captures the exam information for inclusion in the family history. Information can include, for example:
Biological sister with breast cancer
Social history—was in Kansas last year (system understands that “last year” is relative to the date this is added) as sister's caretaker.
Patient says that despite the emotional strain of caring for her sister, she has been feeling pretty ok, emotionally. Provider enters into the HPI “Pt denies depression” (the system captures for inclusion in the review of systems)
   Sample Note:
      Chief complaint: “I'm worried about my diabetes”
      HPI draft: No medical f/u in over 1 yr. Was in Kansas much of the time taking care of sister with breast cancer—surgery, chemo, RT—now in remission. Was a sig. strain on her own health but better now and denies depression, insomnia, anxiety, etc. Unfortunately has not taken either her metformin or her statin regularly in several months. Has gained weight as well—not following any particular diet.

The provider also reviews recent vitals (e.g., from MA, licensed practical nurse (LPN), etc., today during rooming, etc.) and lab results (e.g., from labs done the days ago in advance of the visit), compares with longitudinal view, and discusses results with the patient:
weight gain with BMI=41.7
elevated BP (145/92)
HgbA1c elevated at 8.4
FBS (Fasting Blood Sugar)=175 (high)
Mild decline in renal function with microalbuminuria c/w diabetic nephropathy
eGFR 60 (low), decrease since last measurement
U microalbumin 90 mg/gCr (elevated), new since last measurement,
LDL 110 (high, increased from previous measurement)

The provider then discusses the meaning and risks of the results with the patient, showing graphs of values over time. The provider enters new goals into system and reviews medications:
Hypoglycemic medication (Diabetes problem):
   Re-initiates metformin prescription for 2000 mg/d
   Declines system suggestion for 2nd hypoglycemic medication (rule conditions—relative non-compliance with metformin (taking less than prescribed dose—refills filled but not as often as if the medication were taken at full dose daily)
      documents rationale: problem caused by non-compliance with metformin, not that the metformin wasn't working
Statin (hyperlipidemia & diabetes problems):
   System indicates a lapse in compliance with atorvastatin (rule conditions—refills were not filled or requested, as they would have been if the patient had been taking it as prescribed)
   Accepts system recommendation to re-initiate statin.
ACEi/ARB (hypertension & diabetic nephropathy ontologies).

The system accepts a system recommendation to initiate angiotensin-converting-enzyme (ACEi) and/or angiotensin-receptor blocker (ARB) treatment for both hypertension and diabetic nephropathy problems. The system retrieves ACEi/ARB choices on the patient's insurance plan formulary and displays the out-of-pocket financial responsibility for each choice. The System performs a check against plan formulary and an eligibility check for patient financial responsibility (e.g., deductible+coinsurance+copayment). This display is integrated into views of medications, for example. For example, the provider chooses Lisinopril™, which is $2.21 per month, because she does not want cost to be a significant hurdle in medication compliance.

The system recommends referrals based on problems. For example, the system recommends an ophthalmology referral for dilated fundoscopic retinal examination. The system order triggers verification that the patient has no evidence of diabetic retinal exam in the past one year, for example, and triggers an explicit benefits inquiry documenting coverage and returning patient's financial responsibility, which is provided to patient with a visit summary by office staff at the end of the encounter. The system can also order an endocrine consult if the provider wants specialty evaluation of an uncontrolled diabetes mellitus (DM) not selected at this visit by the provider (there is also a possibility of a rule for system recommendation based on an elevated A1c>9.0, etc.). The system accepts additional system recommendations, triggered by significant weight gain and elevated A1c for medical nutrition therapy and diabetic self-management education, for example. The system can also order a podiatry referral, wherein the system recommendation can be also triggered by an abnormal foot exam performed during the patient visit, for example. The system recommends follow up based on one or more problems:
Diabetes problem recommends follow up in 2 months (based on risk stratification)
Hypertension problem recommends follow up in 2 weeks (based on risk stratification)
System auto-fills a follow up appointment request for 2 weeks from now, which the provider can change if they want to

The system also recommends education (e.g., disease management, diet, etc.). For example, patient education modules for “Diet & Exercise in the Management of Diabetes” and “Self Monitoring Blood Sugar Levels” can be provided, etc.

As the provider is completing billing documentation, the system leverages an existing problem of “diabetes type II” (ICD9 250.00 no mention of complication, not uncontrolled) as a billing diagnosis for the office visit. Based upon recent test results and provider interventions, the system provides feedback that the patient has evidence of “diabetes type II, uncontrolled” (250.02) and “diabetes with renal manifestations” (ICD9 250.42), for example. The PCP updates the problem list as suggested by accepting the most specific diagnosis (250.42) for the problem list update and the encounter billing. In certain examples, the system advises that an additional code for level of chronic kidney disease (CKD) is needed to support “diabetes with renal manifestation”, and suggests an ICD9 585.3 CKD stage 3 based upon recent estimated Glomerular filtration rate (eGFR) of 60. The provider accepts the system recommendation, and the additional problem is entered along with diagnosis (Dx) code for billing. In certain examples, the recommendation can also include a coding suggestion for morbid obesity (ICD-278.01), which is ignored.

Thus, certain examples enable ingestion of information and evaluation of rule(s) to generate a patient care plan. Certain examples facilitate monitoring of patient data and comparison to evaluate compliance with the care plan and satisfaction of a goal for the patient. In certain examples, the care plan and/or goal are modified if the goal is not being attained and/or the care plan is not being followed.

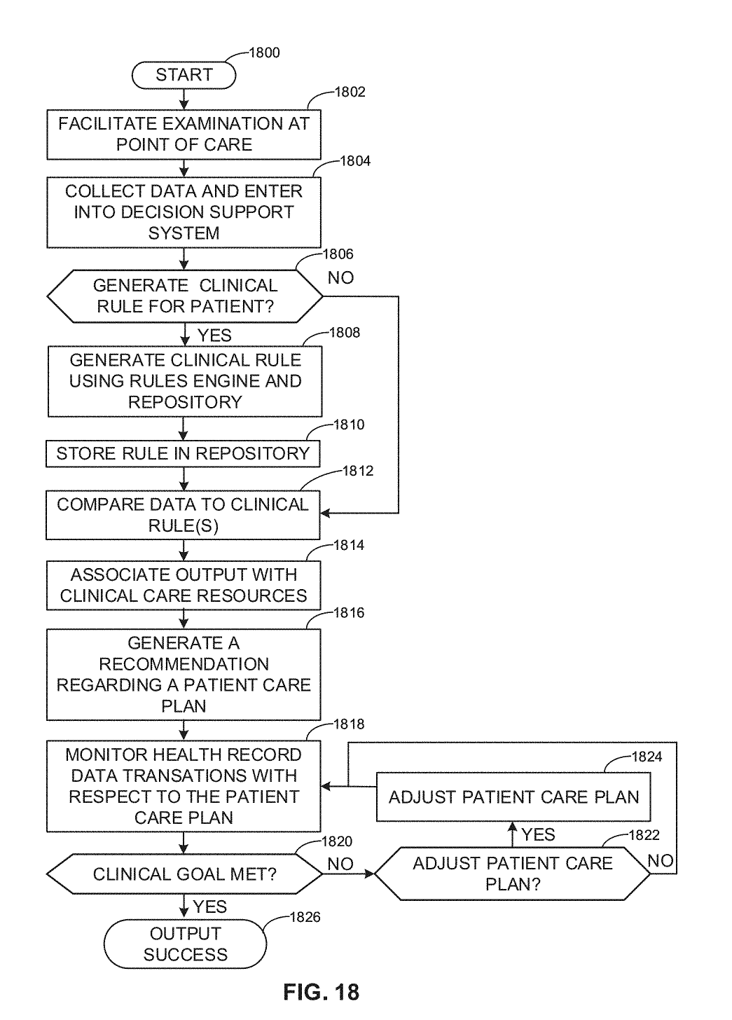

FIG. 18 illustrates a flow diagram of an example method 1800 of patient care plan and rule composition, monitoring, and adjustment using the example rules engine 640 and associated clinical decision support 1603. At block 1802, examination is facilitated at a point of care. For example, a doctor examines a patient and orders lab tests and images for the patient. At block 1804, data is collected and entered into the CDS 1603. For example, results of the lab tests and collected, analyzed image data are entered into the CD 1603 as well as the patient's EMR 1605.

At block 1806, the data is evaluated to determine if the data satisfies an existing clinical rule and/or if a clinical rule is to be created for the patient. If a rule is to be created, then, at block 1808, the rule engine 640 and associated repository are leveraged to create a new rule based on existing relationships, repository information, and patient data. At block 1810, the created rule is stored in the rules repository 724, 812, 1202, 1406.

At block 1812, collected data (e.g., via health transaction monitoring, etc.) is compared to the rule(s). For example, the data is processed according to the rule(s) specified for the patient. At block 1814, a resulting output is associated with one or more clinical resources for patient care (e.g., test, equipment, imaging, exam, etc.). At block 1816, a patient care plan is generated based on the processed data and rule(s) analysis output. For example, a plan of test(s), image acquisition, other examination, etc., is developed and recommended for the patient.

At block 1818, health record data transactions are monitored with respect to the patient's care plan. For example, data transactions can be monitored and compared to elements of the care plan to evaluate compliance with and/or satisfaction of the care plan and associated goal. At block 1820, the goal is evaluated to determine whether the goal has been met through the data activity (e.g., transaction data shows certain exams have been done, certain tests came back with acceptable results within a specified range or value, etc.).

If the goal has not been met, then, at block 1822, the care plan, goal, and monitored data are evaluated to determine whether the patient care plan should be adjusted. At block 1824, if the care plan is to be adjusted, the care plan is adjusted. For example, based on monitored data, rules, and status of compliance with the existing care plan, the plan is modified to better and/or differently address the goal (and/or the goal is adjusted to be met by the care plan, etc.). Control then reverts to block 1818 to monitor health record data transactions. Once the clinical goal has been met, then, at block 1826, an indication of success is output (e.g., visually on a display screen, electronically via message and/or file to one or more recipients, electronically as a data transfer to an EMR, CDS, and/or other system, etc.

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not list may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

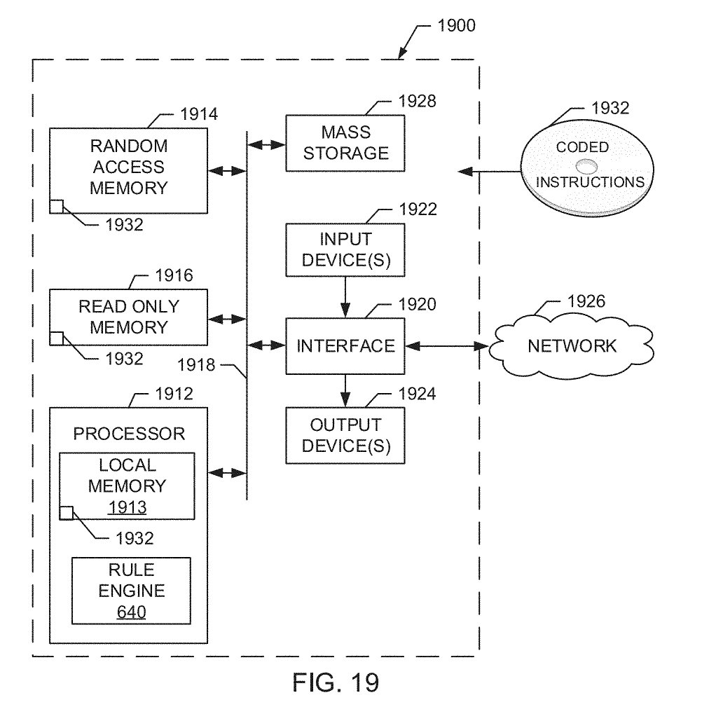

FIG. 19 is a block diagram of an example processor platform 1900 capable of executing instructions to implement the example systems and methods of FIGS. 1-18. The processor platform 1900 can be, for example, a server, a personal computer, a mobile device (e.g., a cell phone, a smart phone, a tablet such as an IPAD′), a personal digital assistant (PDA), an Internet appliance, or any other type of computing device.

The processor platform 1900 of the illustrated example includes a processor 1912. Processor 1912 of the illustrated example is hardware. For example, processor 1912 can be implemented by one or more integrated circuits, logic circuits, microprocessors or controllers from any desired family or manufacturer.

Processor 1912 of the illustrated example includes a local memory 1913 (e.g., a cache). Processor 1912 of the illustrated example is in communication with a main memory including a volatile memory 1914 and a non-volatile memory 1916 via a bus 1918. Volatile memory 1914 can be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1916 can be implemented by flash memory and/or any other desired type of memory device. Access to main memory 1914, 1916 is controlled by a memory controller. The processor 1912, alone or in conjunction with the memory 1913, can be used to implement the rule engine 640 and/or other part of the systems disclosed herein.

Processor platform 1900 of the illustrated example also includes an interface circuit 1920. Interface circuit 1920 can be implemented by any type of interface standard, such as an Ethernet interface, a universal serial bus (USB), and/or a PCI express interface.

In the illustrated example, one or more input devices 1922 are connected to the interface circuit 1920. Input device(s) 1922 permit(s) a user to enter data and commands into processor 1912. The input device(s) 1922 can be implemented by, for example, an audio sensor, a microphone, a camera (still or video), a keyboard, a button, a mouse, a touchscreen, a track-pad, a trackball, isopoint and/or a voice recognition system.

One or more output devices 1924 are also connected to interface circuit 1920 of the illustrated example. Output devices 1924 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). Interface circuit 1920 of the illustrated example, thus, typically includes a graphics driver card, a graphics driver chip or a graphics driver processor.

Interface circuit 1920 of the illustrated example also includes a communication device such as a transmitter, a receiver, a transceiver, a modem and/or network interface card to facilitate exchange of data with external machines (e.g., computing devices of any kind) via a network 1926 (e.g., an Ethernet connection, a digital subscriber line (DSL), a telephone line, coaxial cable, a cellular telephone system, etc.).

Processor platform 1900 of the illustrated example also includes one or more mass storage devices 1928 for storing software and/or data. Examples of such mass storage devices 1928 include floppy disk drives, hard drive disks, compact disk drives, Blu-ray disk drives, RAID systems, and digital versatile disk (DVD) drives.

Coded instructions 1932 associated with any of FIGS. 1-20 can be stored in mass storage device 1928, in volatile memory 1914, in the non-volatile memory 1916, and/or on a removable tangible computer readable storage medium such as a CD or DVD.

It may be noted that operations performed by the processor platform 1900 (e.g., operations corresponding to process flows or methods discussed herein, or aspects thereof) may be sufficiently complex that the operations may not be performed by a human being within a reasonable time period.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a rule engine including a particularly programmed processor to process ingested clinical data for a patient with respect to a goal, identify a rule applicable to the clinical data and goal for the patient, and apply the rule to the clinical data to generate at least one of an action or a suggestion for the patient based on applying the rule to the clinical data, the at least one of an action or a suggestion applicable to a care plan for the patient to achieve the goal; and
a rule repository storing rules and associated information for access by the rule engine.

2. The system of claim 1, wherein the rule engine is to generate a rule based on the goal and the clinical data for the patient, the rule engine to store the generated rule in the rule repository.

3. The system of claim 1, further including a practice management subsystem to monitor patient data and provide to the rule engine to determine at least one of compliance with the care plan or progress to the goal.

4. The system of claim 1, wherein the rule engine and the repository are provided in a clinical decision support system.

5. The system of claim 4, wherein the clinical decision support system operates with at least one of a practice management system or an electronic medical record system to evaluate data, develop the care plan, monitor activity, and determine compliance with the care plan toward the goal.

6. The system of claim 1, wherein the rule engine generates an alert when applying the rule to the ingested clinical data does not satisfy the rule.

7. The system of claim 1, further including a user interface for rules authoring.

8. A tangible computer-readable storage medium including instructions which, when executed, particularly configure a processor to implement a system, the system comprising:
a rule engine to process ingested clinical data for a patient with respect to a goal, identify a rule applicable to the clinical data and goal for the patient, and apply the rule to the clinical data to generate at least one of an action or a suggestion for the patient based on applying the rule to the clinical data, the at least one of an action or a suggestion applicable to a care plan for the patient to achieve the goal; and
a rule repository storing rules and associated information for access by the rule engine.

9. The storage medium of claim 8, wherein the rule engine is to generate a rule based on the goal and the clinical data for the patient, the rule engine to store the generated rule in the rule repository.

10. The storage medium of claim 8, wherein the system implemented by the executed instructions further includes a practice management subsystem to monitor patient data and provide to the rule engine to determine at least one of compliance with the care plan or progress to the goal.

11. The storage medium of claim 8, wherein the rule engine and the repository are provided in a clinical decision support system.

12. The storage medium of claim 11, wherein the clinical decision support system operates with at least one of a practice management system or an electronic medical record system to evaluate data, develop the care plan, monitor activity, and determine compliance with the care plan toward the goal.

13. The storage medium of claim 8, wherein the rule engine generates an alert when applying the rule to the ingested clinical data does not satisfy the rule.

14. The storage medium of claim 8, wherein the system implemented by the executed instructions further includes a user interface for rules authoring.

15. A computer-implemented method comprising:
processing, using a processor, ingested clinical data for a patient with respect to a goal;
identifying, using the processor, a rule applicable to the clinical data and goal for the patient;
applying, using the processor, the rule to the clinical data to generate at least one of an action or a suggestion for the patient based on applying the rule to the clinical data, the at least one of an action or a suggestion applicable to a care plan for the patient to achieve the goal.

16. The method of claim 15, further including:
generating a rule based on the goal and the clinical data for the patient;
storing the generated rule in a rule repository.

17. The method of claim 15, further including monitoring patient data and providing the monitored patient data to the processor to determine at least one of compliance with the care plan or progress to the goal.

18. The method of claim 15, wherein the processor is to implement a rule engine provided in a clinical decision support system.

19. The method of claim 18, wherein the clinical decision support system operates with at least one of a practice management system or an electronic medical record system to evaluate data, develop the care plan, monitor activity, and determine compliance with the care plan toward the goal.

20. The method of claim 15, further including generating an alert when applying the rule to the ingested clinical data does not satisfy the rule.
